(19) United States
(12) Patent Application Publication
(10) Pub. No.: US 2015/0363481 A1
(43) Pub. Date: Dec. 17, 2015

(54) Systems, Devices, and/or Methods for Managing Information

(71) Applicant: Michael N. Haynes, Keswick, VA (US)

(72) Inventor: Michael N. Haynes, Keswick, VA (US)

(21) Appl. No.: 14/012,339

(22) Filed: Aug. 28, 2013

Related U.S. Application Data
(60) Provisional application No. 61/697,345, filed on Sep. 6, 2012.

(51) Int. Cl. G06F 17/30

(52) U.S. Cl. CPC G06F 17/30595

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, automatically generating a story regarding a predetermined topic from a plurality of assertions.

### BRIEF DESCRIPTION OF THE DRAWINGS

A wide variety of potential, feasible, and/or useful embodiments will be more readily understood through the herein-provided, non-limiting, non-exhaustive description of certain exemplary embodiments, with reference to the accompanying exemplary drawings in which:
FIG. 1 is a block diagram of an exemplary embodiment of a system 1000;
FIG. 2 is a block diagram of an exemplary embodiment of an information device 2000;
FIG. 3 is a flowchart of an exemplary embodiment of a method 3000;
FIG. 4 is a screenshot of an exemplary user interface 4000;
FIG. 5 is a screenshot of an exemplary user interface 5000;
FIG. 6 is a screenshot of an exemplary user interface 6000; and
FIG. 7 is a screenshot of an exemplary user interface 7000.

### DESCRIPTION

Introduction. Genealogy involves the study of unified lineages, while family history involves the study of those related by familial and other close interpersonal relationships, even if not genetic or marital.

Undoubtedly, genealogy is a relatively popular hobby. Yet although many people are interested in their kin, most make little effort to seriously pursue the research needed to discover their kin and/or details of their lives. Instead, probably the vast majority of people, including those who are not serious genealogists, tend to be more interested in hearing and reading engaging narratives about entities (e.g., people, events, and/or places) with which they have some form of relationship, with perhaps an implicit goal of trying to better understand the experiences, perceptions, beliefs, feelings, and/or perspectives, etc., of the characters of those narratives. Thus, an alternative objective of genealogy, or even its umbrella term, family history, can be the crafting, drafting, and sharing of interesting narrative or descriptive “stories” that provide details about the context of those reader-relevant entities.

From the perspective of a storytelling family historian, no tools (e.g., integrated computer software applications) seem to be available today that fully empower that historian to:
1. identify, pursue, and log relevant family history research tasks;
2. orderly record and present an evidenced description and/or argument built using alleged and/or proven facts of significant relevance to each identified person, and;
3. craft, evidence, and widely share interesting and/or immersive stories based on selected facts from such descriptions.

Ideally, that description might explain, for each alleged, proven, and/or asserted fact (“assertion”):
who=the person(s) to whom it is relevant;
what=its nature;
when=the time (or period over which) it is relevant;
where=the place for which it is relevant; and/or
how/why=its relevant details.

Note that the presented evidence and/or reasoning supporting the assertions of a story can be crucial for enabling others to verify, trust, and further research those assertions.

Tools. Common activities of a genealogist, family historian, and/or storyteller can be facilitated by one or more computer software applications. For example, certain exemplary embodiments can manually, semi-automatically, and/or automatically store and/or communicate any predetermined family history related information, data, and/or meta-data via, e.g., a digital file, database, and/or database management system (DBMS). If a digital file is utilized, the digital file can be given a filename that uniquely and/or reasonably clearly identifies the file and/or its content.

Thus, family history related information can be communicated via any of a number of manners, including, e.g.:
verbally;
printed page, newsletter, manuscript, and/or book;
microfilm, microfiche, etc.;
magnetic and/or optical media;
digital file formatted as TXT, DOC, DOCX, GEDCOM, PDF, XML, HTML, etc.;
central, served, local, synchronized, distributed, and/or peer-to-peer data storage approach, data-sharing mechanism, and/or database;
assertion, passage, story, and/or wiki;
free and/or commercial website;
desktop, mobile, and/or web-based application software;
etc.

In certain exemplary embodiments, a database and/or DBMS file(s) can be created and/or accessed via selected and/or predetermined DBMS software, such as, for example, Access, DB2, FileMaker Pro, Informix, Ingres, MySQL, OpenBase, Oracle, PostgreSQL, SQL, SQL Anywhere, SQL Server, SQLite, and/or Sybase, etc. The DBMS can have any of the following characteristics: user-programmable, client-server, master-servant, peer-to-peer, local, networkable, remote, hosted, server-deployable, mobile, web-deployable, web-accessible, web-publishable, Lasso-compatible, Python-compatible, Ruby-compatible, PHP-compatible, XML-compatible, XSLT-compatible, browser-compatible, mobile device compatible, SQL table-connectable, ODBC-compatible, JDBC-compatible, LDAP-compatible, record-level-locking, field-level-locking, securable, multi-user, ACID-compliant, cross-platform, single-threaded, multi-threaded, synchronized, SQL-based, procedural, custom data validation, hierarchical, multi-dimensional, networkable, object-oriented, and/or relational.

Certain exemplary embodiments can specify, design, create, store, transmit, provide, have, rely on, access, and/or manage one or more user-programmable, user-modifiable, and/or user-selectable DBMS and/or database structures, schemas, engines, user interfaces, files, tables, fields, table occurrences, relationships, objects, languages, transaction mechanisms, external data sources, formulas, calculations, validations, layouts, forms, views, queries, reports, charts, portals, buttons, icons, tooltips, links, keyboard equivalents, scripts, custom functions, plug-ins, extensions, drivers, macros, subroutines, libraries, code, controls, settings, preferences, options, tools, value lists, menus, accounts, custom access privileges and/or permissions, etc.

For example, in certain exemplary embodiments, the DBMS can define, provide, and/or utilize any number of inter-related tables and/or fields. For example, with respect to family history related information, in certain exemplary embodiments, an exemplary DBMS can define, provide, and/or utilize a table containing fields for entering, storing, searching, communicating, and/or rendering records and/or data for, associated with, and/or that describes any of the following types of family history related information: activities, uses, users, submissions, collections, assertions, individuals, families, groups, relationships, time, timespans, places, areas, objects, events, attributes, repositories, sources, citations, links, digital files, comments, tags, arguments, grades, quality indicators, authorities, privileges, subscriptions, accounts, etc. (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected). Any of these tables can be inter-related, either dynamically and/or statically, with any other table.

To consistently illustrate one or more exemplary embodiments, DBMSs, and/or potential database tables, assume that a given family history researcher is interested in someone referred to as John Boyd, who is alleged to have been born in 1815 in Franklin County, Virginia to a William and Sarah Boyd. This John Boyd is also alleged to have married Leatha Moore on 27 Dec. 1836 in Floyd County, Virginia.

Users. In certain exemplary embodiments, an exemplary DBMS can define, provide, and/or utilize a Users table and/or corresponding fields, such as fields for entering, storing, searching, communicating, and/or rendering records and/or data for, associated with, and/or that describe one or more users (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), for example, fields such as:
UserID (e.g., a unique record identifier for a given user);
UserAuthenticator (e.g., one or more values that help authenticate the identity of the user, such as a password, passphrase, and/or key, etc.);
UserType (e.g., a description of the user's capabilities, such as:
   Submitters: those permitted to submit, enter, revise, and/or delete records and/or data for family history related information, e.g.: activities, uses, users, submissions, collections, assertions, individuals, families, groups, relationships, time, timespans, places, areas, objects, events, attributes, repositories, sources, citations, links, digital files, comments, tags, arguments, grades, quality indicators, authorities, privileges, subscriptions, etc.
   Viewers and/or Subscribers: those permitted to access, receive, and/or view family history related information and/or changes to it;
   Graders: those permitted to access, view, grade, and/or comment upon family history related information;
   Editors: those permitted to access, receive, view, grade, comment upon, edit, and/or suggest edits to family history related information;
   Owners: those permitted to submit, enter, revise, delete, access, view, grade, comment upon, edit, and/or suggest edits to family history related information, and/or control other user's access to it; and/or
   Administrators: those permitted to assign, change, and/or remove ownership of family history related information, and/or create, revise, and/or delete accounts, etc.
   etc.;
UserRating (e.g., one or more user-provided self-ratings regarding personal perceptions of levels of expertise, experience, and/or understanding of any of various designated categories of family history related information);
and/or fields and/or data related to the identity of that user;
etc.

In certain exemplary embodiments, a submitter who submits family history related information (e.g., one or more data, records, collections, assertions, citations, links, eFiles, tags, comments, arguments, grades, etc.) can, potentially subject to third party copyright, own that family history related information, retain that ownership after submission, and/or have the right to remove the family history related information from the system.

In certain exemplary embodiments, a submitter who submits certain information (e.g., assertions, links and/or e-Files, etc.) can edit and/or delete that submitted item, but not necessary other information (e.g., tags, comments, arguments, and/or grades, etc., e.g., if provided by that submitter and/or others).

Individuals. In certain exemplary embodiments, an exemplary DBMS can define, provide, and/or utilize an Individuals table and/or corresponding fields, such as fields for entering, storing, searching, communicating, and/or rendering records and/or data for, associated with, and/or that describe one or more individuals (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), e.g., a person, group, club, class, association, partnership, company, organization, institution, and/or legal entity, etc., for example, fields such as:
IndividualiD (e.g., a unique record identifier for a given individual);
FamilyName (e.g., the surname of the individual, e.g., “Boyd”, “The Headwaters Methodist Church”, “Franklin County High School”, “The Visionaries, LLC”, etc.);
GivenName (e.g., the first, middle, and/or other names of the individual, e.g., “John”, “Class of '79”, etc.);
Prefix (e.g., a title and/or honorific for the individual, such as Mr., Mrs., Ms., Miss, Sir, The Honorable, Duke, Dr., etc.);
Suffix (e.g., an honorific and/or distinguisher of the individual, such as Esquire, Esq., Ph.D., Senior, Sr., Junior, Jr., I, II, III, “Cross-Country Team”, “Advanced Algebra”, etc.);
NickName (e.g., a shorthand identifier for the individual, e.g., “Gunsmith Billy”, “Uncle Festus”, “Cousin It”, “The Marching Cobras”, etc.);
Alias (e.g., other full names by which the individual was known, e.g., “John Jackson Boyd”, “The Wild Ones”, “CX84”, etc.);
Gender (e.g., “male”, “M”, “female”, “F”, “unknown”, “?”, “NA”, etc.).
and/or fields and/or data related to the identity of that individual;
etc.

Times. In certain exemplary embodiments, an exemplary DBMS can define, provide, and/or utilize a Times table and/or corresponding fields, such as fields for entering, storing, searching, communicating, and/or rendering records and/or data for, associated with, and/or that describe one or more times (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.) of and/or associated with family history related information, for example, fields such as:
TimelD (e.g., a unique record identifier for a given time);
TimeYear (e.g., a year associated with the given time);
TimeMonth (e.g., the month of the given time);
TimeDay (e.g., the day of the given time);
TimeHour (e.g., the hour of the given time);
TimeMinute (e.g., the minute of the given time);
TimeSecond (e.g., the second of the given time);
TimeSystem (e.g., the time zone, reference, and/or standard associated with the given time);
TimeGMT (e.g., the GMT equivalent of the given time);
and/or fields and/or data related to the time, e.g.:
   any durations that apply between the time and another predetermined, user-specified, and/or user-selected time (e.g., “in his 53^{rd} year”; “nearly a year before the bombing of Pearl Harbor thrust the U.S. into WWII”; etc.)
   etc.;
etc.

Certain exemplary embodiments can provide a time and/or date calculator that can determine, e.g., a duration between two dates, a date occurring a given duration away from another date, and/or a day of week of a given date, etc. Certain exemplary embodiments can provide a time and/or date converter that can convert a given time into, e.g., a desired format and/or time zone, etc.

Places. In certain exemplary embodiments, an exemplary DBMS can define, provide, and/or utilize a Places table and/or corresponding fields, such as fields for entering, storing, searching, communicating, and/or rendering records and/or data for, associated with, and/or that describe one or more places (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.) of and/or associated with family history related information, for example, fields such as:
PlaceID (e.g., a unique record identifier for a given place);
PlaceSuperContinent (e.g., the super-continent of the place, e.g., Latin America=Central America+South America);
PlaceContinent (e.g., the continent of the place);
PlaceSubContinent (e.g., the sub-continent of the place, e.g., sub-Saharan Africa; Nordic countries, etc.);
PlaceCountry (e.g., the country of the place);
PlaceRegion (e.g., the sub-country region of the place, e.g., New England, the MidWestern U.S., etc.);
PlaceState (e.g., the state and/or province of the place, e.g., Texas, British Columbia, etc.);
PlaceCounty (e.g., the county and/or parish of the place);
PlaceTown (e.g., the city and/or town of the place);
PlaceNeighborhood (e.g., the community and/or neighborhood of the place);
PlaceAddress (e.g., the street address of the place);
PlaceBuilding (e.g., the building of the place);
PlaceRoom (e.g., the room of the place);
PlaceTag (e.g., a tag and/or nickname for the place, e.g., the “White House”, the “parlor”, the “Mack Patch”, etc.);
PlaceGPS (e.g., the Global Positioning System coordinates of the center of the place);
PlaceGPSBoundaries (e.g., the GPS coordinates of the corners of the place);
and/or fields and/or data related to the place, e.g.:
   any areas spanned by the place (e.g., “the farm covered nearly 300 acres”);
any distances (e.g., direct, roadway, etc.) between the place and another predetermined, user-specified, and/or user-selected place (e.g., “nearly 5 miles from Headwaters over narrow dusty roads, but only 3 miles as the crow flies”);
   etc.;
etc.

Note that multiple records, each containing at least some data that conflicts with the others, can be entered for a given place. For example, if one source refers to a place as “Franklin Co. VA”, and another source reports that place as “Franklin County, Virginia”, both descriptions can be entered, stored, and/or presented for that place. The order of presentation can be predetermined (e.g., alphabetical), user-specified, and/or user-selected.

Events. In certain exemplary embodiments, an exemplary DBMS can define, provide, and/or utilize an Events table and/or corresponding fields, such as fields for entering, storing, searching, communicating, and/or rendering records and/or data for, associated with, and/or that describe an event (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), for example, fields such as:
EventlD (e.g., a unique record identifier for a given event);
IndividualID (e.g., a unique record identifier for each individual to whom the event applies)
EventType (e.g., a label and/or tag classifying the event, e.g., birth, christening, bas mitzvah, education, enrollment, graduation, achievement, newsworthy, immigration, emigration, residence, gathering retirement, injury, illness, death, burial, cremation, etc.);
EventName (e.g., a nickname or common descriptor for the event, e.g., “the 2009 Boyd Family Reunion”, “Aunt Tilly's Retirement”, “Cousin Morticia's Graduation”, etc.)
EventTime (e.g., a time associated with the event);
   TimelD (e.g., a unique record identifier for a given time);
   TimeType (e.g., whether the given time is associated with a “beginning”, “occurrence”, and/or “ending”);
   TimePrecision (e.g., an indication of the certainty associated with the given time, e.g., “on”, “about”, “abt.”, “circa”, “c.”, “around”, “approximately”, “approx . . . ”, “before”, “between”, “after”, etc.);
EventPlace (e.g., a place associated with the event)
   PlaceID (e.g., a unique record identifier for a given place);
   PlaceTime (e.g., when the description of the place applies (e.g., then, now, or both)
   etc.
and/or fields and/or data related to the event;
etc.

Note that multiple records, each containing at least some data that conflicts with the others, can be entered for a given event. For example, for our exemplary John Boyd, if a first source reports his birthdate as “1 Mar. 1815” and no birth location, a second source reports his birthdate as “6 Mar. 1815” and “VA”, and a third source provides no birthdate, but provides a birthplace of “Franklin County, Virginia”, information regarding each reported birth event can be entered, cited, stored, and/or presented for that individual. The order of presentation can be predetermined (e.g., chronological), user-specified, and/or user-selected.

Attributes. In certain exemplary embodiments, an exemplary DBMS can define, provide, and/or utilize an Attributes table and/or corresponding fields, such as fields for entering, storing, searching, communicating, and/or rendering records and/or data for, associated with, and/or that describe one or more attributes (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as an accomplishment, physical feature, belief, behavior, and/or possession, etc., of one or more given individuals, for example, fields such as:
AttributelD (e.g., a unique record identifier for a given attribute);
IndividualiD (e.g., a unique record identifier for each individual to whom the attribute applies)
AttributeType (e.g., a label and/or tag classifying the attribute), e.g.:
   accomplishment, e.g., construction, completion, discovery, creation, writing, and/or innovation, etc. (e.g., John Boyd discovering a cave on his property, completing his tobacco harvest, and/or learning to spell his name, etc.);
   activity, e.g., quest, project, pastime, sport, recreation, amusement, entertainment, and/or hobby, etc. (e.g., playing a fiddle);
   advocation, e.g., education, experience, vocation, occupation, employer, and/or talent, etc. (e.g., rancher);
   behavior, e.g., personality, social style, mannerism, peculiarity, fear, pet peeve, preference, habit, addiction, dysfunction, obsession, compulsion, and/or delusion, etc.;
   belief, e.g., factual, religious, philosophical, and/or political, etc., belief, etc.;
   culture, e.g., ethnicity, origin, tribe, group, clan, etc., group-specific behavior, customs, language, dialect, accent, etc.;
   financial, e.g., wealth, business, investment, intangible personal property, and/or charity, etc.; and/or
   media, e.g., document, painting, photo, and/or video; etc.;
   physical feature, e.g., height, weight, eye color, hair color, hair style, voice style, accent, skin color, build, disfigurement, marking, disability, condition, disease, and/or injury, DNA, haplotype, haplogroup, allele, SNP, STR, mtDNA, Y-DNA, mutation, DNA marker, ethnicity, etc.;
   possession, e.g., jewelry, memorabilia (quilt, trophy, medal, etc.), collection (coins, stamps, etc.), car, tool, firearm, implement, toy, object, tangible personal property, real property, land, building, residence, rent or own?, home type, home size, chattel, pet, and/or livestock, potentially including nickname and/or descriptor for that possession (e.g., “grandpa Smith's harmonica”, “Chance the cow”, etc.), etc.;
   preference/favorite, e.g., food, recipe, restaurant, garment, color, music, artist, art, style, comedy, venue, place, sight, celebrity, movie, show/channel, web site, book, game, sport, sports team, and/or quote, etc.;
   etc.;
AttributeDescription (e.g., a description of the attribute, e.g., “hot fudge sundaes” for favorite dessert, and/or “blue” for eye color, etc.)
AttributeName (e.g., a nickname or common descriptor for the attribute, e.g., “SSN”, “Quirks”, “Favorite Poem”, etc.)
AttributeTime (e.g., a time associated with the attribute);
   TimelD (e.g., a unique record identifier for a given time);
   TimeType (e.g., whether the given time is associated with a “beginning”, “occurrence”, and/or “ending”);
   TimePrecision (e.g., an indication of the certainty associated with the given time, e.g., “on”, “about”, “abt.”, “circa”, “c.”, “around”, “approximately”, “approx . . . ”, “before”, “between”, “after”, etc.);
AttributePlace (e.g., a place associated with the attribute)
   PlaceID (e.g., a unique record identifier for a given place);
   PlaceTime (e.g., when the description of the place applies (e.g., then, now, or both)
and/or one or more fields and/or data related to the attribute;
etc.

Relationships. In certain exemplary embodiments, an exemplary DBMS can define, provide, and/or utilize a Relationships table and/or corresponding fields, such as fields for entering, storing, searching, communicating, and/or rendering records and/or data for, associated with, and/or that describe one or more relationships (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as a relationship between one or more given individuals based on, e.g.:
membership (military service, fraternity, tribe, team, club, union, etc.);
occupation (employer, training, profession, etc.);
achievement (award, certification, title, etc.);
interest (e.g., hobby, activity, fan club, etc.);
place (e.g., gathering spot, neighborhood, nationality, etc.);
event (attend, participate, impacted by, etc.); and/or
other attribute (preference, activity, etc.);

for example, fields such as:
RelationshiplD (e.g., a unique record identifier for a given individual);
Individuall (e.g., the name of one entity in the relationship);
Individual2 (e.g., the name of another entity in the relationship);
Individual3 (e.g., the name of yet another entity in the relationship); and/or
RelationshipType (e.g., a classification of the relationship and/or a selected individual's role(s) in that relationship, such as:
   familial, marriage, spouse, husband, wife, parent, father, mother, child, sibling, sister, brother, biological, natural, adoption, adopter, adoptee, step, step-parent, step-child, etc.;
   social, acquaintance, friendship, friend, colleague, lover, member, etc.;
   residential, domestic partnership, roommate, neighbor, etc.;
   occupational, boss, supervisor, manager, employer, employee, workmate, master, slave, servant, apprentice, etc.;
   financial, owner, business partnership, partner, shareholder, seller, buyer, renter, supplier, vendor, service provider, customer, client, patient, etc.
   legal, juror, judge, witness, victim, wrongdoer, lawyer, prosecutor, clerk, etc.;
   educational, professor, teacher, instructor, aid, student, classmate, study partner, etc.; and/or
   recreational, team, coach, teammate, competitor, rival, etc.;
   etc.;
RelationshipTime (e.g., a time associated with the relationship);
   TimelD (e.g., a unique record identifier for a given time);
   TimeType (e.g., whether the given time is associated with a “beginning”, “occurrence”, and/or “ending”);
   TimePrecision (e.g., an indication of the certainty associated with the given time, e.g., “on”, “about”, “abt.”, “circa”, “c.”, “around”, “approximately”, “approx . . . ”, “before”, “between”, “after”, etc.);
RelationshipPlace (e.g., a place associated with the relationship)
   PlaceID (e.g., a unique record identifier for a given place);
   PlaceTime (e.g., when the description of the place applies (e.g., then, now, or both)
and/or one or more fields and/or data related to the relationship;
etc.

Certain exemplary embodiments can provide a relationship calculator that can determine the consanguinity, kinship, meioses, and/or “blood relation” between and/or separating any two individuals.

Sources. Information regarding individuals, families, groups, events, attributes, etc. can be obtained from any of many potential sources, which can include physical objects, human memories, and/or physical and/or digital documents, images, audio recordings, video recordings, animations, models, and/or simulations, etc.

A given source can present, describe, and/or contain any of numerous types of records, data, and/or information, such as birth records, marriage records (e.g., marriage bonds, licenses, registrations, etc.), mortality records, death records, cemetery records (e.g., burial surveys, headstones, etc.), obituaries, wills, probate and/or estate-oriented records, census records, land and/or real estate transaction records, surveys, maps, tax records (e.g., real property, personal property, income, sales, etc.), welfare-oriented records (e.g., court decisions binding out children, social security applications, etc.), immigration records, ship's manifests, education records (e.g., certificates, diplomas, etc.), occupational records (e.g., apprenticeship, union membership, etc.), military records (e.g., conscription, service, pension, etc.), medical records, legal records (e.g., civil proceedings, criminal proceedings, administrative proceedings, jury duty, etc.), church records (e.g., christening, baptism, communion, bar mitzvah, last rites, etc.), directories (e.g., trade, street, telephone, etc.), awards, diaries, family bibles, scrapbooks, correspondence (e.g., letters, postcards, notes, envelopes, e-mail messages, etc.), articles (e.g., in newspapers, newsletters, magazines, web sites, etc.), biographies, books, paintings, drawings, photographs, audio recordings, video recordings, personal interviews, genealogical compilations (e.g., family trees, GEDCOM files, books, etc.), unpublished documents, notes, etc.), and/or genetic and/or DNA test results, etc.

A given source can have a commonly accepted name (e.g., “The Declaration of Independence”). A given source can have an identified speaker, author, editor, publisher, vendor, and/or provider, etc. (e.g., “Thomas Jefferson”), as well as one or more corresponding times and/or places (e.g., a date of publication (e.g., “4 Jul. 1776”), a place where written (e.g., “Independence Hall, Philadelphia, Pa., U.S.A”), the correspondence address of the author (e.g., “Monticello, Charlottesville, Albemarle County, Va., U.S.A.”, etc.). A given source can be available in any of various formats, such as verbal, paper, handwriting, drawing, sketch, painting, print out, photograph, mechanical recording, vinyl record, magnetic recording, cassette tape, video tape, microfilm, microfiche, digital, magnetic (e.g., hard drive, floppy, etc.), optical (e.g., CD, DVD, etc.), network-accessible (e.g., web page), human readable, and/or machine readable, etc. Those sources available via digital and/or electronic files can be formatted in one or more standard, proprietary, and/or open source file and/or data formats. For example, sources can be formatted according to any of the following file and/or data formats: GEDCOM, GEDCOM 5.5, GEDCOM XML 6.0, GEDCOM X, XML, JSON, HTML, PDF, searchable PDF, text, TXT, ASCII, Unicode, UTF-8, UTF-16, UTF-32, EBCDIC, ISO 8859, ISO 2022, Windows-1250 ; through 1258, Mac OS Roman, JIS X 0208, JIS X 0213, Guobiao, Big5, HKSCS, KS X 1001, ANSEL, CSV, tab-delimited text, DOC, DOCX, RTF, JPG, TIFF, PNG, BMP, GIF, PCX, PGM, PCT, PSD, TGA, and/or WMF, etc. Access to a source can be unlimited and/or limited, such as to touching, viewing, searching, copying, photographing, duplicating, linking, distributing, and/or editing.

A given source can be an original or a copy, image, derivative, compilation, transcript (entire), extract (partial), abstract (summary), translation, interpretation, etc. A given sources can be classified as “primary”, meaning that the source's recording was created contemporaneously by an eyewitness to an event, or “secondary”, meaning that the source's data was compiled by a non-eyewitness and/or well after the event, and thus might have a higher potential for error.

A given source can have an accepted, appropriate, preferred, formal, informal, and/or corresponding identity, name, type, description, place, specialty, format, etc.

In certain exemplary embodiments, an exemplary DBMS can define, provide, and/or utilize a Sources table and/or corresponding fields, such as fields for entering, storing, searching, communicating, and/or rendering records and/or data for, associated with, and/or that describe one or more sources (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a source.

Repositories. A given source can be accessed (obtained, reviewed, edited, etc.) from one or more repositories, that is, sets of sources generally accessible at and/or from a particular place. A given repository can have an accepted, appropriate, preferred, formal, informal, and/or corresponding identity, name, description, place, specialty, type (e.g., archive, courthouse, library, commercial information provider, etc.), etc. A given repository can have established times of operation and/or accessibility and/or charges and/or other requirements for admission, membership, subscription, and/or source access. A given source can be accessible at one or more particular places in a particular repository, such as in, at, and/or on a particular building, floor, room, shelf, microfilm roll, drive identifier, filepath, filename, link, URL, etc. associated with that repository. A given source can be accessed at a particular repository by a particular researcher at a particular time.

In certain exemplary embodiments, an exemplary DBMS can define, provide, and/or utilize a Repositories table and/or corresponding fields, such as fields for entering, storing, searching, communicating, and/or rendering records and/or data for, associated with, and/or that describe one or more repositories (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a repository.

eFiles. In some cases, a source, a copy of the source, and/or portion of the source can be located, accessed, referenced, reviewed, and/or obtained by a researcher. For example, a researcher might find, read, review, peruse, transcribe, extract, abstract, photocopy, photograph, duplicate, download, digitally copy and paste, and/or otherwise obtain or reference any portion of a given source. In some cases, that portion can be stored, referenced, and/or accessed as a multimedia, digital, and/or “electronic” file and/or content (herein an “eFile”). That eFile can have a filename, file format, address (e.g., file path, link, URL, and/or URI) (a “link”), description, author, creation date, etc. A given eFile can have one or more associated administrators, creators, submitters, owners, authorized users, security settings, privileges, permissions, and/or access control criteria.

In certain exemplary embodiments, an exemplary DBMS can define, provide, and/or utilize an eFiles table and/or corresponding fields, such as fields for entering, storing, searching, communicating, and/or rendering records and/or data for, associated with, and/or that describe one or more eFiles (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of an eFile.

Citations. A first researcher can link any portion of a given source to a given assertion (regarding e.g., an individual, relationship, event, attribute, etc.) via a citation, which can provide sufficient detail (e.g., section, chapter, page, line, and/or field, etc.) regarding the source for a later and/or second researcher to access the portion of the source that the first researcher found relevant. A citation can identify when and/or where a given source was accessed by the first and/or second researcher.

In certain exemplary embodiments, an exemplary DBMS can define, provide, and/or utilize an Citations table and/or corresponding fields, such as fields for entering, storing, searching, communicating, and/or rendering records and/or data for, associated with, and/or that describe one or more citations (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a citation.

Comments. A user can record one or more comments regarding any family history related information, including, e.g., its one or more citations, sources, repositories, eFiles, arguments, grades, submitters, graders, and/or any individual, relationship, event, attribute, etc. related to that family history related information.

For example, a user might note, potentially via a field, a blog, and/or a chat room and/or forum posting, that an 1838 personal property tax record for Franklin County, Virginia regarding John Boyd shows an unusual increase in the number of sheep he owned, and that the corresponding 1839 records shows a similar number of sheep, thereby confirming that the 1938 increase was not due to a clerical error in the records. As another example, a grader might provide a comment and/or explanation for awarding a given submission and/or assertion a low grade.

In certain exemplary embodiments, an exemplary DBMS can define, provide, and/or utilize a Comments table and/or corresponding fields, such as fields for entering, storing, searching, communicating, and/or rendering records and/or data for, associated with, and/or that describe one or more comments (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a comment.

Arguments. For any given assertion regarding an individual, relationship, event, attribute, etc., an argument and/or proof can be entered, stored, and/or presented. For example, the argument can be one or more explanations of why one or more source citations provides sufficient evidentiary support for a given assertion to be deemed credible. As another example, an argument can be presented that explains that the appearance of John Boyd on both the 1838 and 1839 Franklin County personal property tax records suggests that John Boyd was likely living in Franklin County in 1838, and perhaps did not move to Floyd County in 1832 as asserted in one source. The argument can have one or more authors, a creation date, one or more edits and/or changes and corresponding editors and editing dates, etc.

In certain exemplary embodiments, an exemplary DBMS can define, provide, and/or utilize an Arguments table and/or corresponding fields, such as fields for entering, storing, searching, communicating, and/or rendering records and/or data for, associated with, and/or that describe one or more arguments (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of an argument.

Collections. In certain exemplary embodiments, a user can select multiple family history related information items, e.g., individuals, relationships, events, attributes, repositories, sources, citations, eFiles, comments, etc., for combination into a named “collection”. For example, a user can combine records for John Boyd with records associated with his descendants into a collection called the “John Boyd Family”. Alternatively, a user can assign all records imported during a particular import session as belonging to a particular collection and/or can export all records belonging to a specified collection.

Any data, record, collection, and/or portion thereof can be exported and/or imported from the database in any of several file formats, such as GEDCOM, GEDCOM 5.5, GEDCOM XML 6.0, GEDCOM X, XML, JSON, PDF, searchable PDF, text, TXT, ANSEL, ASCII, Unicode, UTF-8, CSV, tab-delimited text, DOC, DOCX, RTF, JPG, TIFF, PNG, etc.

Certain exemplary embodiments can utilize data and/or metadata validation, and/or potentially manipulate any table, field, family history related information, collection, record, and/or data, as needed for maximum and/or optimum compatibility, such as with other software programs, formats, and/or standards. For example, each given date associated with an individual can be validated and/or “sanity-checked”, e.g., upon demand, entry, import, export, and/or subscription, etc., to verify that, based on the other dates for that individual and/or others related to that individual, the given date seems reasonable. For example, a birth and/or death date that, upon comparison with the other dates associated with that individual and/or others related to that individual, suggest that the individual lived longer than 120 years, can be flagged, highlighted, noted, reported, and/or challenged, such as prior to, during, and/or after its entry, import, and/or export.

As another example, family history related information, such as individuals, times, places, events, attributes, repositories, sources, citations, and/or eFiles, etc., can be automatically reviewed to verify they are presented in proper format. For example, times can be validated as being in the desired format “DD-MMM-YYYY” (e.g., “04-Jul-1776”) or “Month DD, YYYY” (e.g., “Jul. 04, 1776”). Likewise, places can be verified as being in the desired format (e.g.: “Co.” not “County (or vice versa); “Virginia” not “VA” (or vice versa); “USA” not “U.S.” or “U.S.A.” (or vice versa); etc.).

As yet another example, repositories, sources, and/or citations can be automatically reviewed to verify they comply with standards and/or specifications such as Evidence Explained: Citing History Sources from Artifacts to Cyberspace, by Elizabeth Shown Mills.

As still another example, data exported in a given format (such as GEDCOM 5.5) can be adjusted for compatibility with that format (such as by, for compatibility with GEDCOM 5.5, creating separate event records for each person associated with a multi-person event). Likewise, upon import and/or export, data can be adjusted as needed knowing the software program from which the data came and/or is destined.

Any given collection can be manually, semi-automatically, and/or automatically combined with, separated from, and/or compared to, any other collection. Thus, a first researcher can obtain an automatic comparison of the records of their collection for the John Boyd Family with those of a somewhat similar collection of a second researcher. The comparison can identify differences between the data of specific fields of specific records, perhaps only if those differences are determined to be significant (e.g., substantive differences as opposed to punctuation differences, differences in dates, additional and/or missing data, etc.).

In certain exemplary embodiments, an exemplary DBMS can define, provide, and/or utilize a Collections table and/or corresponding fields, such as fields for entering, storing, searching, communicating, and/or rendering records and/or data for, associated with, and/or that describe one or more collections (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a collection.

Risk Management and/or Trust Enhancement. Certain exemplary embodiments can utilize various techniques to help manage risks and/or enhance trust in the system and/or in its users by its data providers (e.g., submitters, graders, and/or graders of graders, etc.) and/or its data consumers (e.g., viewers, subscribers, and/or downstream service providers, etc.). For example, data providers can have any of several concerns, such as a failure, over the short and/or long term, to adequately, fully, and/or optimally acknowledge, reward, compensate, utilize, protect, and/or maintain their contributions. Similarly, data consumers can be concerned about a failure, over the short and/or long term, to adequately, fully, and/or optimally:
discourage, reduce, and/or minimize the submission of poor quality contributions;
avoid and/or prevent loss of submissions having utility and/or value; and/or
reduce, discourage, and/or prevent exploitation of that user.

Likewise, any and/or all users can be concerned about disfavored, manipulative, and/or abusive social practices, such as cyber-bullying, phishing, and/or defamation.

Grades. Thus, for example, via certain exemplary embodiments, one or more grades, evaluations, and/or ratings can be entered, stored, analyzed, ranked, and/or presented for one or more collections, assertions, arguments, citations, eFiles, users, and/or submitters, etc. The grade can reflect, at a given time, the grader's assessment of the quality (e.g., legibility, accuracy, contemporaneousness, completeness, objectivity, readability, prose, style, structure, relevance, utility, value, appropriateness, copyright compliance, veracity, credibility, verifiability, and/or trustworthiness, etc.) of one or more collections, submissions, assertions, arguments, citations, and/or eFiles, and/or (directly and/or indirectly) the submitter of that graded item.

Certain exemplary embodiments can allow and/or require the grader to provide one or more justifications, explanations, and/or reasons for awarding the selected grade. These reasons can be standardized and/or freeform, and/or can enable a user, the submitter, an administrator, and/or the system to better understand the basis for the grade, determine if the grade is appropriate and/or credible, and/or consider, discount, increase, adjust, and/or discard the grade accordingly.

To help avoid central tendency bias, grading scales can have a relatively small and even number of selections. For example a four “point” or selection grading scale can be utilized, where:
0=garbage/useless,
1=currently unacceptable, but potentially salvagable,
2=acceptable, and
3=excellent,

thus “forcing” the grader to decide whether the graded item is acceptable or unacceptable, and/or to what general degree.

Although the following exemplary 4 point scale can be aimed specifically at grading the credibility of some and/or all assertions, it can be adapted for grading collections, submissions, submitters, arguments, comments, eFiles, and/or grading reasons, etc.:
“Proven”, “Solid”, or “Certainly”: The grader has no reasonable doubt about the assertion, based upon sound research, good evidence, and/or convincing reasoning.
“Supported”, “Likely”, or “Probably”: The grader believes the assertion is more likely than not, based upon sound research, good evidence, and/or convincing reasoning.
“Might”, “Plausibly”, or “Possibly”: The grader believes some evidence and/or reasoning supports the assertion, but the assertion is not yet satisfactorily proved.
“Unlikely”, “Disproven”, “Impossible”: The grader believes that the evidence and/or reasoning does not support, and/or disproves, the assertion.

Likewise, certain exemplary embodiments can utilize a 2 point grading system (e.g., “OK”/“Not OK”), and/or even a 1 point system, similar to the familiar thumbs up and/or “Like” approach popularized by Facebook.

Certain exemplary grading systems can function as a “flag” and/or other mechanism for signaling that the graded item is inappropriate (e.g., obscene, vulgar, overly inflammatory, abusive, and/or illegal, etc.) and/or should be removed from the system.

A submitter who submits poor quality contributions can earn grades reflective of such work, such that other users can be appropriately warned before subscribing to, using, and/or evaluating contributions of that submitter.

In addition to submitted data and/or their submitters, graders also can be graded by other users and/or by the system. For example, assume grader X consistently and without satisfactory explanation awards very low grades to records submitted by submitter Z, who otherwise receives very high grades for those same records from a significant number of users. Thus, it appears that the very low grades issued by grader X are undeserved, erroneous, and/or reflective of hostility toward submitter Z. In certain exemplary embodiments, other users who have graded the same records of submitter Z can award grader X a low grade. Alternatively, the system can recognize the discrepancy between the grades of grader X and those of other graders regarding the records submitted by submitter Z, and automatically assign a low grade to grader X.

In certain exemplary embodiments, an exemplary DBMS can define, provide, and/or utilize an Grades table and/or corresponding fields, such as fields for entering, storing, searching, communicating, and/or rendering records and/or data for, associated with, and/or that describe one or more grades (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a grade.

Quality Indicators. Via certain exemplary embodiments, multiple grades, perhaps provided by multiple graders, can be combined (e.g., via addition, averaging, weighted averaging, etc.) to provide an overall quality indicator (“QI” in singular form, which can be pronounced “chee”, and/or “QIs” in plural form, which can be pronounced “cheese”) for one or more submissions, assertions, arguments, citations, eFiles, submitters, and/or graders, etc. at a given time. Thus a QI can serve as an overall “grade” and/or indicator of the potential value provided by a given family history related information, data, assertion, record, note, citation, eFile, argument, collection, grader's grades/opinion, and/or submitter, etc.

For example, assume submitter Z submits a first eFile containing an image of the marriage “return” signed by Minister Jonathan Turner for the 27 Dec. 1836 marriage of John Boyd and Leatha Moore in Floyd County, Virginia, and links that eFile to our exemplary John Boyd. Assume ten (10) other users review this eFile, strongly agree that it appears to be genuine, accurate, and credible, and seems to be properly linked to our John Boyd, and thereby each award the highest possible grade (e.g., 4 points) to this eFile. To arrive at a QI for this eFile, these 10 grades can be combined (e.g., added (e.g., 40 points), averaged (e.g., 4 points), weighted averaged (assume 3.8 points), time-weighted averaged (assume 3.6 points), and/or grader-weighted average (assume 3.75 points), etc.).

Now assume submitter Z submits a second eFile containing an extract of land tax records for Montgomery County, Virginia for the years 1853 to 1858 for a John Q. Boyd, and links this second eFile to our exemplary John Boyd. Assume ten (10) other users review this eFile, find that although it appears to be accurate and credible, it seems to be improperly linked to our John Boyd, and thereby award a rather low grade (e.g., 1.2 points) to this eFile. To arrive at a QI for this eFile, these 10 grades can be combined (e.g., added (e.g., 12 points), averaged (e.g., 1.2 points), weighted averaged (assume 1.3 points), time-weighted averaged (assume 1.1 points), and/or grader-weighted average (assume 0.9 points), etc.).

Based on these two submissions, a QI for submitter Z can be calculated, such as by adding (e.g., 52 points), averaging (e.g., 2.6 points), weighted averaging (assume 2.55 points), etc.

Thus, by presenting grades, grading reasons, and/or a QI for submitter Z, the system can empower other users to better recognize the likely quality (e.g., credibility, value, etc.) of submitter Z's submissions and/or better rank and/or filter those submissions. The impact of this sort of feedback can be profound, potentially encouraging ever higher quality collections, submissions, assertions, arguments, citations, eFiles, and/or grading, etc.

Such an approach can be “self-healing”, adaptive, and/or dynamic. For example, if a given submission earns a low QI, the submitter can improve that low QI by deleting, correcting, and/or enhancing the submission. Assuming its graders are notified of the corrective action, they can delete, change, or re-assert their earlier grade. As another example, for time-weighted grading, newer grades can have a higher weight than older grades, thus allowing the impact of poor older grades on the QI to be ameliorated by higher newer grades. Similarly, the accumulation of higher grades can diminish the impact of lower grades. Yet, because a user can potentially be presented with a QI, grades, and/or reasons for not only a submitter, but also a given submission (e.g., collection, assertion, argument, citation, and/or eFile, etc.), the user can better determine how to treat that submission.

Certain exemplary embodiments can manually, semi-automatically, and/or automatically apply one or more predetermined, user-selected, default, and/or otherwise specified (yet potentially additively-correlated) weights to one or more predetermined, user-selected, default, and/or otherwise specified QI types, grades, etc. For example, a user-selectable (yet additively-correlated) weighting could apply to a relevance score and a legibility score (e.g., the 2 weights could be required to add to a fixed value, such as 1.0, so that if the user chooses a weight of 0.7 for the relevance score, the weight for the legibility score must be 0.3).

In certain exemplary embodiments, an exemplary DBMS can define, provide, and/or utilize a QIs table and/or corresponding fields, such as fields for entering, storing, searching, communicating, and/or rendering records and/or data for, associated with, and/or that describe one or more QIs (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a QI.

Privileges. In certain exemplary embodiments, a given family history related information (e.g., collection, record, data, assertion, argument, citation, source, eFile, comment, grade, QI, etc.) can have one or more associated users (e.g., submitters, owners, viewers, subscribers, editors, councils, and/or administrators, etc.). In certain exemplary embodiments, a given user of an family history related information can have one or more associated “privileges” (e.g., security settings, permissions, and/or access control criteria, etc.). Such privileges can help protect a given submitter's submissions, such as from unintended, undesired, and/or unrewarded access and/or sharing, premature release, privacy breach, etc. Certain exemplary embodiments can allow an associated user of any given family history related information to deny, authorize, change, and/or provide desired, required, and/or appropriate privileges to any other user and/or user type, such as privileges to access, view, copy, adopt, grade, annotate, edit, own, and/or administer, etc., that given family history related information.

For example, the submitter, owner, and/or administrator of a collection called “John and Leatha Boyd Descendants” can authorize a user known as “Cousin Morticia” to manage a portion of that collection called the “Uncle Festus Descendants” sub-collection, and thereby access, view, copy, annotate, edit, grade, and/or delete any record and/or data in that sub-collection.

As another example, a given submitter can submit one or more records and/or collections, create a “user group” that includes several other users, and give each of the members of that user group with adequate privileges to view, annotate, and/or grade those records and/or collections.

In certain exemplary embodiments, an exemplary DBMS can define, provide, and/or utilize a Privileges table and/or corresponding fields, such as fields for entering, storing, searching, communicating, and/or rendering records and/or data for, associated with, and/or that describe one or more privileges (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a privilege.

Subscriptions. Certain exemplary embodiments can provide a family history related social networking service. For example, via certain exemplary embodiments, a user can “subscribe” to any selected family history related information (e.g., collection, individual, relationship, assertion, event, attribute, repository, source, citation, eFile, comment, argument, submitter, etc.), where the subscription can provide any of several possible services. By way of further example, a subscription can notify (e.g., via e-mail, instant message, posting, and/or RSS feed, etc.) the subscriber of any changes to the selected family history related information.

As another example, by virtue of the subscription, the subscriber can be notified of only “significant” changes in the selected family history related information, where “significant” can be predefined and/or specified by the subscriber, such as for example, when a new family history related information (e.g., argument, citation, and/or eFile, etc.) is associated with a subscribed assertion, and/or when the new family history related information is submitted by a submitter having a minimum grade and/or QI, and/or, when a subscribed family history related information changes substantially (e.g., factual differences as opposed to punctuation differences, differences in dates, additional and/or missing data, etc.), etc.

In certain exemplary embodiments, an exemplary DBMS can define, provide, and/or utilize a Subscriptions table and/or corresponding fields, such as fields for entering, storing, searching, communicating, and/or rendering records and/or data for, associated with, and/or that describe one or more subscriptions (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a subscription.

Accounts. Certain exemplary embodiments can provide some and/or each user of the tool with an individual and/or group account. The account can be associated with a username and/or a multi-factor authentication mechanism that is based on one or more: ownership factors, i.e., something the user has (e.g., wrist band, ID card, security token, physical key, software token (e.g., cryptographic key), phone, or cell phone); knowledge factors, i.e., something the user knows (e.g., a password, pass phrase, or personal identification number (PIN), challenge response (the user must answer a question)); and/or inherence factors, i.e., something the user is or does (e.g., fingerprint, retinal pattern, DNA sequence, signature, face, voice, unique bio-electric signals, or other biometric identifier).

For each account, data associated with a profile can be entered, stored, and/or presented, the profile data providing user-selected and/or user-entered details about that user, such as name, screen name and/or user name, mailing address, telephone number, e-mail address, SMS and/or instant messaging address, messaging settings and/or preferences, credit card and/or other financial and/or billing details, language preferences, self-demographic and/or background information, tool preferences, device preferences, security and/or sharing settings, profile photo, etc.

Any given account can be associated with one or more information, such as one or more collections, individuals, relationships, events, attributes, repositories, sources, citations, eFiles, comments, arguments, submissions, submitters, privileges, and/or subscriptions, etc.

In certain exemplary embodiments, an exemplary DBMS can define, provide, and/or utilize an Accounts table and/or corresponding fields, such as fields for entering, storing, searching, communicating, and/or rendering records and/or data for, associated with, and/or that describe one or more accounts (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of an account.

Authorities. Via certain exemplary embodiments, a submitter can identify one or more other users to serve on a “council” that can be responsible for the submitted data and/or information. For example, a council can designate a substitute owner and/or administrator to serve in the event of the withdrawal, incapacity, and/or death of the submitter. As another example, a council can resolve disputes regarding a given submission and/or family history related information. For example, assume that a submitter, Joe Doe, submits a controversial argument proposing and/or explaining, for instance, why a given citation is not valid evidence of a particular assertion, or why the available evidence supports a particular conclusion. The council, which can have an odd number of members to help avoid tie votes, can vote whether to accept and/or endorse the argument.

Multiple councils can belong to one or more “super-councils”. For instance, a council that is responsible for data relating to the “John Boyd Family” (and/or its descendants) can in turn belong to a “Boyd's In Virginia” council, which can belong to a “Boyd's in America” council and/or a Boyd's council. Alternatively, a flatter hierarchy can be implemented, in which all councils belong to a single super, supreme, and/or overarching council that is responsible, for example, for resolving inter-council and intra-council disputes, setting requirements for councils, and/or setting requirements for users, subscriptions, submitters, accounts, etc.

In certain exemplary embodiments, an exemplary DBMS can define, provide, and/or utilize an Authorities table and/or corresponding fields, such as fields for entering, storing, searching, communicating, and/or rendering records and/or data for, associated with, and/or that describe one or more authorities (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of an authority.

Data Validation. Certain exemplary embodiments can apply data validation techniques to help find, flag, correct, and/or avoid potential data entry and/or submission errors. For example, Mary Smith didn't really have a child 10 years after she died, did she? As another example, did John Boyd actually live for 140 years, as a hypothetical mistaken submission asserts? Was he born before his father? Did he reside in both Virginia and Indiana at the same time? Did he father over 15 children?

Tags. In certain exemplary embodiments, any data, record, and/or collection can be tagged with a private and/or public tag. For example, if a given researcher discovers a record for a John Q. Boyd who owned land in Montgomery County, Virginia from 1853 to 1858, that record can be privately tagged as “potential”, “our John Boyd?”, “ours?”, “unlinked”, “unlikely”, “disproven”, “not ours”, “not the Franklin/Patrick County John Boyd”, etc.

In certain exemplary embodiments, an exemplary DBMS can define, provide, and/or utilize a Tags table and/or corresponding fields, such as fields for entering, storing, searching, communicating, and/or rendering records and/or data for, associated with, and/or that describe one or more tags (past, present, and/or future) (e.g., alleged, asserted, recorded, evidenced, proven, witnessed, experienced, determined, calculated, selected, conceived, forecasted, expected, predicted, extrapolated, contemplated, proposed, envisaged, visualized, envisioned, imagined, contrived, estimated, and/or projected, etc.), such as, for example, any of the above-described aspects, descriptors, and/or characteristics of a tag.

Storage. In various exemplary embodiments, family history related information such as data, meta-data, and/or eFiles, etc., can be stored in a central hosted repository and/or can be stored according to a distributed and/or peer-to-peer model. If distributed, family history related information can be stored on the drives of one or more users.

The Family History Process. Very generally, the family history process can be divided into 3 primary activities, namely:
1. researching: targeting, finding, and/or logging potential family members (and/or other potentially relevant people) and/or potential details of their lives;
2. asserting: evidencing, arguing, and/or presenting relevant alleged and/or proven facts; and
3. storytelling: crafting, drafting, and/or sharing highly engaging fact-based narrative and/or descriptive accounts of at least a portion of the lives of family members.

Researching. The research activity can begin by identifying and/or logging one or more research targets, i.e., what is sought and/or the thing of interest (e.g., the person, relationship, event, attribute, time, period, place, and/or region, etc.) via a question, statement, and/or hypothesis, etc., such as:
“When was my great-grandmother Sarah born?”;
“John Boyd was married in the early 1830's in southern Virginia”; and/or
“William Moore was born with the surname ‘Gallimore’”.

Next, potential repositories, sources, and/or search criteria that might relate to the research target, such as for answering and/or proving the question/statement/hypothesis, can be identified. For example, to determine whether John Boyd married in the early 1830's and relevant details of any such marriage, potentially relevant searches might involve:
Repository: Library of Virginia; Source: Franklin County Marriage Register: 1830-1831; Query: surname of “Boyd”, “Boid”, “Boyt”, etc.;
Repository: Library of Virginia; Source: Franklin County Marriage Register: 1832-1833; Query: surname of “Boyd”, “Boid”, “Boyt”, etc.;
Repository: Library of Virginia; Source: Franklin County Marriage Register: 1834-1835; Query: surname of “Boyd”, “Boid”, “Boyt”, etc.;
Repository: Floyd County Courthouse; Source: Floyd County Marriage Register: 1830-1833; Query: surname of “Boyd”, “Boid”, “Boyt”, etc.;
Repository: Floyd County Courthouse; Source: Floyd County Marriage Register: 1834-1837; Query: surname of “Boyd”, “Boid”, “Boyt”, etc.;
etc.

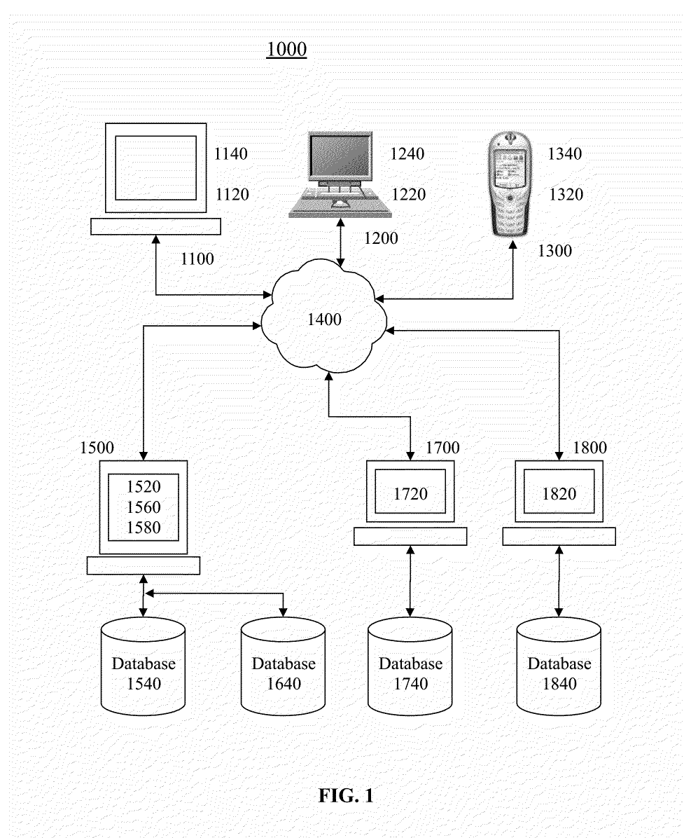

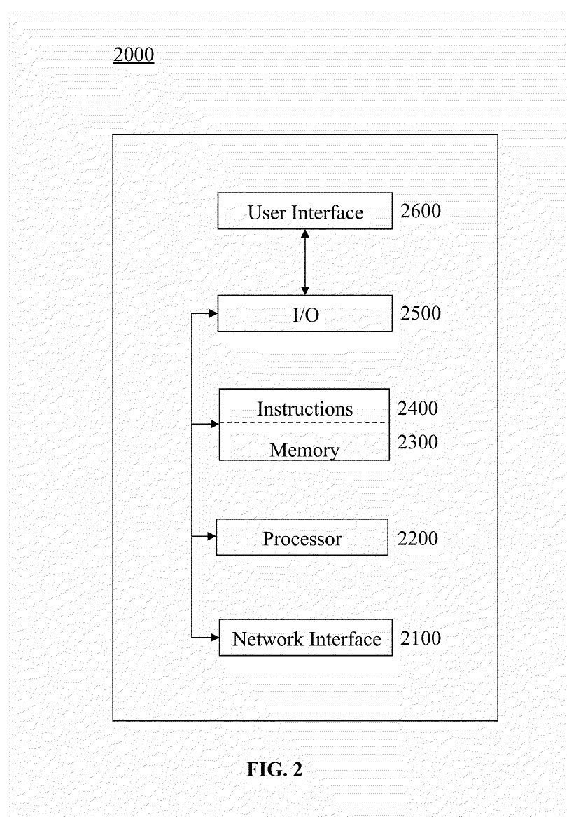

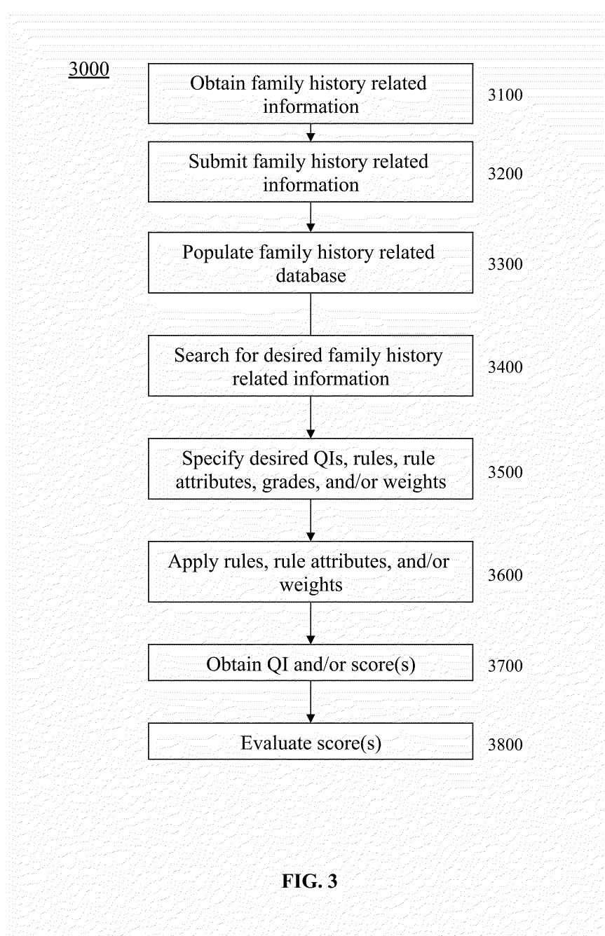

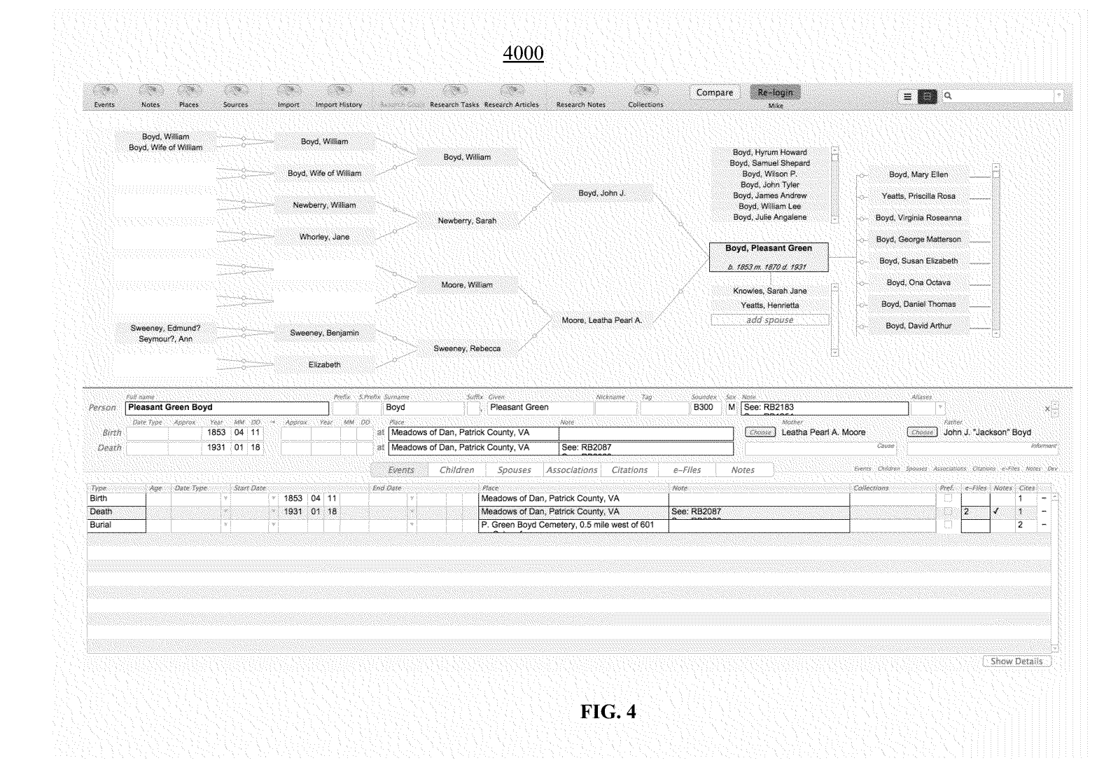

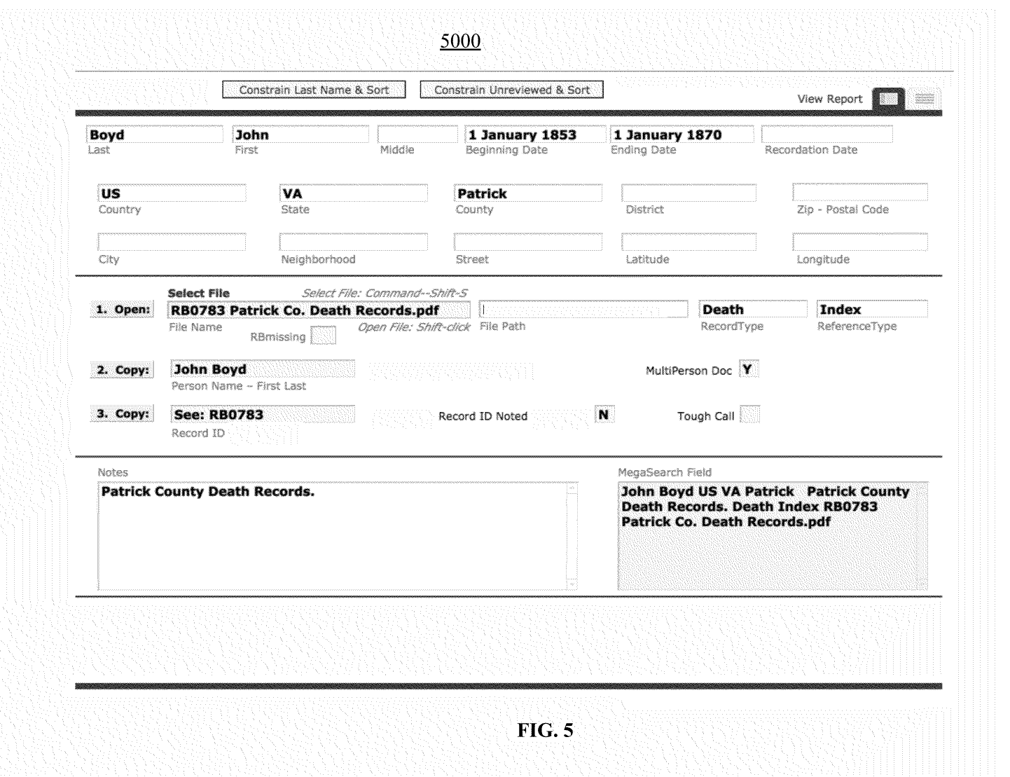

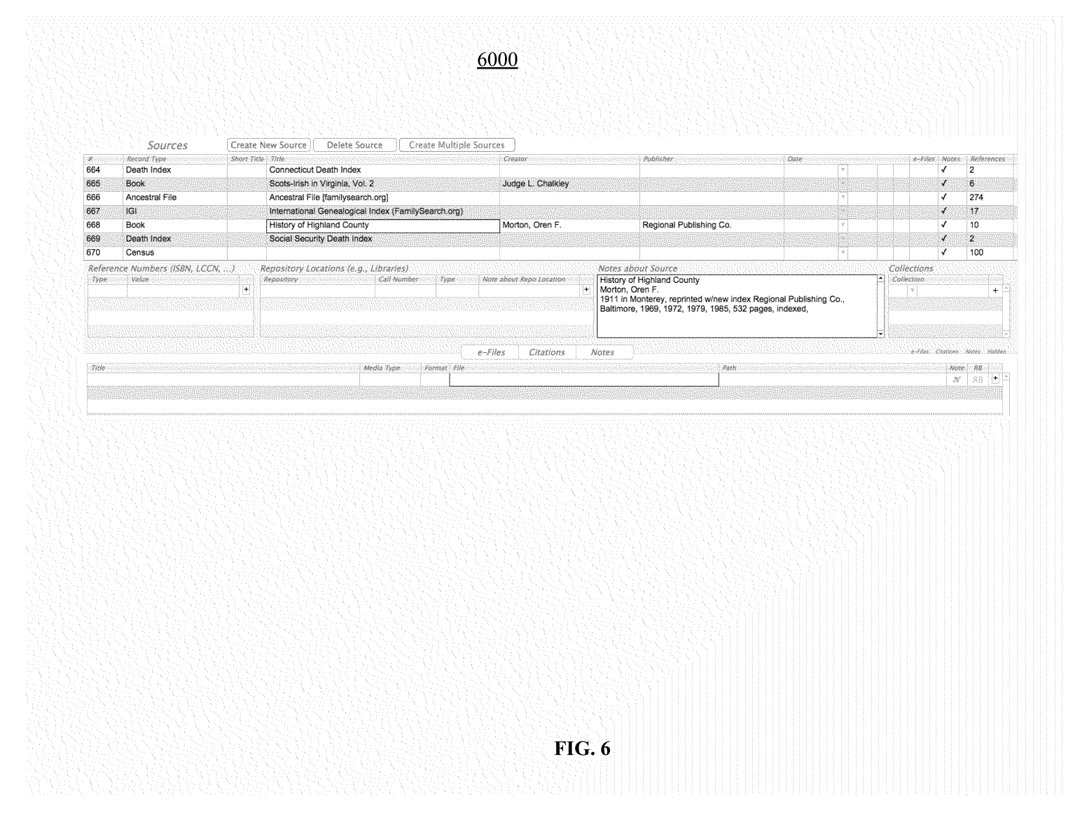

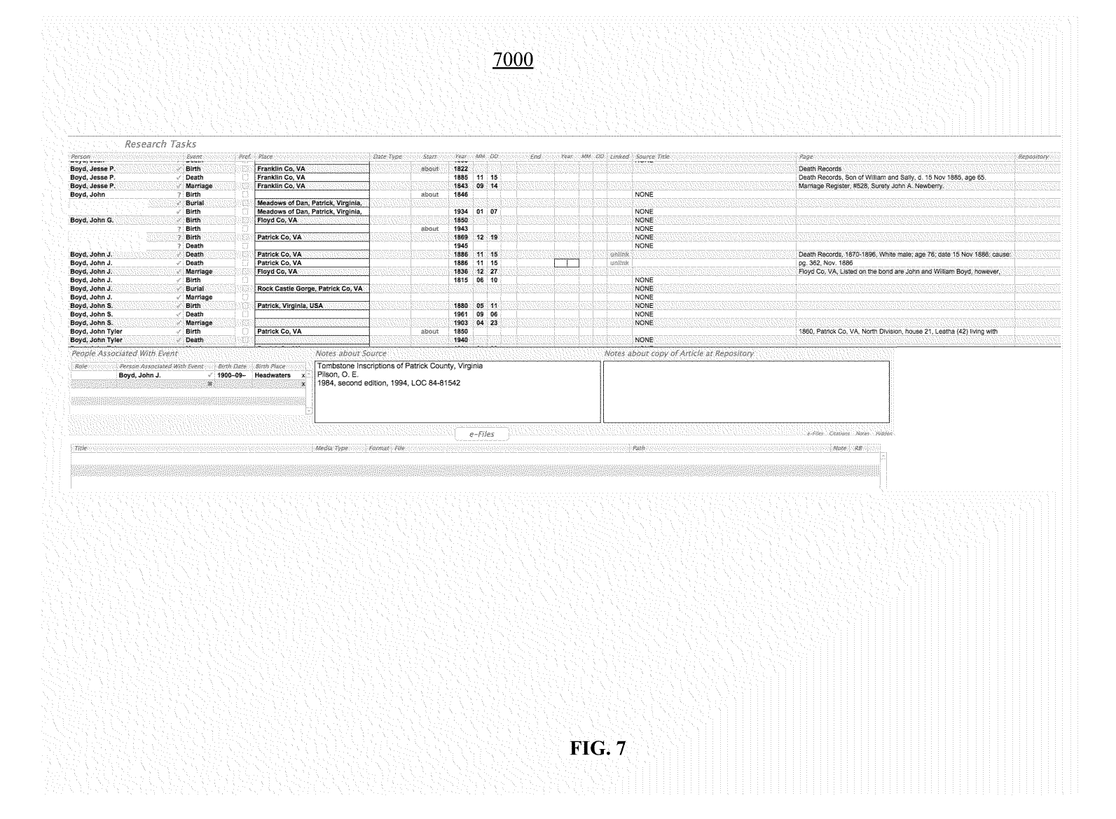

Next, the researcher can determine a particular repository and/or source to search, can access one or more particular repositories and/or sources, and/or can search those sources. Whether a search results in relevant information or not, the repository, source, and/or search criteria can be logged, described, and/or cited in relation to the corresponding thing of interest, such as shown in FIG. 7. For example, for each research task (i.e., combination of target, repository, source, and/or search criteria, etc.), data can be recorded regarding, e.g.:
whether the repository was checked;
whether the source was available;
whether the source was found;
whether the source was legible;
the apparent credibility of the source;
whether any apparently relevant content was found;
where in the source the content was found;
the apparent credibility of the content;
whether an electronic record (eFile) of the content was obtained;
the storage location of the eFile;
any transcript (full), extract (partial), abstract (summary), translation, interpretation, notes, etc. of and/or regarding the content was created;
etc.

Such data can be stored, for example, via one or more related database tables containing one or more relevant fields, and/or can be useful for guiding future research and/or researchers.

As implied above, once a source is accessed and/or searched, its content can be analyzed to determine one or more of its qualities, such as its relevance, utility, veracity, credibility, and/or trustworthiness, etc., and/or can be graded accordingly.

Content that is and/or tends to be anti-supportive of a given target can be carefully recorded, analyzed, and/or noted. For example, content indicating that John Boyd was married in the late 1820's could be considered anti-supportive of a research target seeking to show that John Boyd was first married in the early 1830's.

As they arise and/or to the extent possible, conflicts between sources can be resolved. For example, a researcher can weigh the quality (e.g., veracity, credibility, and/or trustworthiness, etc.) of a given source and/or a particular portion of that source. Although a high quantity of references to a source and/or the predetermined portion of that source might reflect the truth, it also might indicate an echo chamber effect (i.e., repetition of an assertion without due research to determine its likely correctness) that should not overwhelm a single more credible conflicting reference. In any event, the quantity of references can be weighed (or not weighted) as desired.

An end goal for the research phase can be the entry and/or presentation of a proof of one or more alleged facts, that is, an argument that:
1. identifies and/or explains a question/statement/hypothesis;
2. identifies potential repositories and/or sources for obtaining evidence regarding the question/statement/hypothesis;
3. presents found facts that allegedly answer the question/statement/hypothesis;
4. identifies evidence of those alleged facts;
5. identifies the sources of that evidence;
6. discusses evidentiary qualities, such as strengths, weaknesses, absences, implications, alignments, and/or conflicts; and/or
7. provdes a reasoned conclusion regarding the question/statement/hypothesis and/or alleged facts.

Asserting. To be useful to those other than the researcher, research results can be asserted, that is, presented in a manner than others can review and/or utilize them. To fulfill this step in the family history context, one can utilize any of a number of techniques and/or formats. For example, a researcher can rely on a database for both entering and asserting relevant family information. Such a database (and/or appropriate unstructured data search algorithms) can provide sufficient structure to allow for rapid and/or powerful searches by others seeking to access and/or leverage the researcher's work.

Fact Finder. Via certain exemplary embodiments, a user can subscribe to any and/or all available, relevant, and/or desired collections, records, data, submissions, assertions, grades, QIs, and/or “facts”, etc. For example, a user can subscribe to some and/or all existing and/or new records and/or data regarding the exemplary John Boyd, b. 1815 in Franklin County, Virginia. Similarly, according to a given subscription, the user can be alerted to any and/or all additions, changes, and/or deletions to any and/or all available, relevant, and/or desired records and/or data, such as records regarding said John Boyd or records involving Franklin County in the 1810's. For instance, a subscriber can be alerted if the grade for a given and/or any assertion regarding John Boyd declines below a predetermined and/or user-selected threshold. Upon receiving such an alert, the subscriber can automatically or manually remove and/or un-associate that assertion from one or more of the subscriber's collections, such as a “public” or shared collection.

In certain exemplary embodiments, upon entering and/or uploading a given collection, a subscriber can request a complete subscription for all data in that collection. In response, for each human entity (individual, family, and/or group, etc.) in that collection, a FactFinder (a computer program and/or “engine”) can first compare identifying data for that human entity with identifying data for similar and/or identical human entities in some and/or all other submitted collections, noting which human entities of the subscriber's collection appear to already exist in one or more of the other submitted collections. To facilitate the comparison, the FactFinder can apply pre-determined and/or user-selected criteria to one or more fields. For example, a user and/or the system can submit, store, determine, identify, and/or propose surnames that might be matches for a given surname, e.g., any of “Boid”, “Boyde”, “Boyt”, “Boyte”, “Boit”, “Boyette”, and/or “Bird”, etc., might be considered potential, phonetic (e.g., via and/or per one or more phonetic algorithms such as SOUNDEX and/or its derivatives and/or competitors (e.g., Metaphone, Double Metaphone, NYSISS, Kolner Phonetik, etc.)), and/or practical matches for “Boyd”. As another example, any of “Jn”, “Jon”, “Johan”, “Johann”, “Jonathan”, etc., might be considered as potential, phonetic, and/or practical matches for “John”. Certain exemplary embodiments can provide a phonetic algorithm calculator, such as a SOUNDEX calculator, to help determine the proper SOUNDEX code for a given surname.

Similarly, a user and/or the system can submit, store, determine, identify, and/or propose a range of dates that will be considered as potential matches for a given date. For example, a range of plus and/or minus a pre-determined, specified, and/or selected range, e.g., 1, 2, 5, and/or 10 years, might be utilized for finding potential and/or actual matches based on an event date, such as a birth date. For example, for John Boyd, the user might specify a birth year range of: precisely 1815; 1810 to 1820; 1815 plus or minus 5 years; or 1815 plus 5 years and minus 2 years; etc.

Likewise, user and/or the system can submit, store, determine, identify, and/or propose a range, proximity, and/or hierarchy of places that will be considered as potential matches for a given place. For example, any of “USA”, “U.S.”, “America”, “Virginia”, “VA”, “Va.”, “Franklin Co.”, “Franklin Cnty”, etc., might be considered as potential, phonetic, and/or practical matches for “Franklin County, Virginia, U.S.A.”.

Thus, in seeking matches for our exemplary John Boyd, a user and/or the system might specify and/or utilize any of the above exemplified search criteria to find potential, phonetic, and/or practical matches for an individual in the user's collection identified as “John Boyd, b. 1815, Franklin County, Virginia, U.S.A.”.

In a similar fashion, one or more other events (e.g., marriage, residence, death, etc.), attributes (e.g., vocation, land ownership, property ownership, etc.), relationships (father, mother, siblings, children, kin, neighbors, etc.), etc., associated with our exemplary John Boyd can be used to seek matches for him.

In seeking matches, those matching precise search criteria (e.g., precise dates) can be graded and/or ranked higher than those matching imprecise search criteria (e.g., falling within a specified date range, but not on the precise specified date). Likewise, those potential “hits” that match narrower search criteria (e.g., “Franklin County”) can be graded and/or ranked higher than those matching broader search criteria (e.g., “Virginia”).

Moreover, an overall match grade and/or score can be determined for each potential match, such that the group of potent matches can be ranked so those most likely to be true are listed first. The overall match score can be determined, for example, by specifying and/or applying a grade for each search criteria, and then compositing (e.g., adding, averaging, weighted averaging, etc.) those individual grades. Using our exemplary John Boyd, surname can have a maximum grade of 20 points, birth date can have a maximum grade of 20 points, and death location can have a maximum grade of 10 points. Those potential matches having a surname of “Boyd” can receive the maximum possible grade, and those having alternative spellings can be graded as follows:
“Boid”=18 points;
“Boyde”=17 points;
“Boyt”=15 points;
“Boit”=15 points;
“Boyette”=12 points; and/or
“Bird”=11 points.

A similar approach can be taken with the first name. For birth date, a potential match having a birth date in 1815 can receive the maximum 20 points, while those within 2 years can receive, e.g., 17 points, those within 5 years can receive e.g., 12 points, and/or those within 10 years can receive, e.g., 5 points. Likewise, those potential matches that include a death location of “Franklin County, Virginia, U.S.A.” (or its equivalents) can receive the maximum grade, those having a location in an adjacent and/or nearby county can receive, e.g., 7 points, those matching only on Virginia (or its equivalents) can receive, e.g., 5 points, and/or those matching only on U.S.A. (or its equivalents) can receive, e.g., 2 points.

Thus, the FactFinder can provide a list of potential matches for all and/or any given person and/or assertion in an identified collection. If desired, a user can subscribe to a given match. Such a subscription can allow a user to replace their “own” data with the subscribed data.

Fact Market. Via certain exemplary embodiments, a submitter can offer to sell, trade, lease, license, and/or fulfill a subscription to one or more other users for access to family history related information, such as information, data, and/or eFiles regarding one or more individuals, relationships, events, attributes, repositories, sources, citations, digital files, comments, and/or arguments, etc. For example, a given submitter can identify and/or provide an eFile containing a photographic image of the marriage “return” by Minister Jonathan Turner for the 27 Dec. 1836 marriage of John Boyd and Leatha Moore in Floyd County, Virginia. That submitter can offer to provide one or more other users with access to that eFile in exchange for: e.g., attribution; payment of a monetary and/or non-monetary price, whether in a traditional currency, a digital currency (such as Bitcoins), or a proprietary currency; and/or access to data desired by the submitter and under the control of the user; etc.

Conversely, via certain exemplary embodiments, a user can offer to buy, trade, lease, license, and/or subscribe to family history related information, such as information, data, and/or eFiles regarding one or more individuals, relationships, events, attributes, repositories, sources, citations, digital files, comments, and/or arguments, etc. For example, a given user can seek access to an eFile containing a photographic image of the Franklin County Virginia land tax records for John Boyd from 1830 to 1850. That user can seek access to that eFile in exchange for: e.g., attribution; payment of a social, financial, monetary, and/or non-monetary price (potentially in a traditional, digital (such as Bitcoins), and/or proprietary, etc.); access to data desired by the submitter and under the control of the user; and/or power, prestige, and/or influence within the system, etc. As another example, a user can offer to pay US$150 and/or 20,000 “kin points” (which can, but need not, have an exchange rate with one or more traditional currencies, such as U.S. dollars, euros, Japanese yen, etc.) for a well-evidenced identification of the paternal grandfather of John Boyd. As yet another example, a user can offer access to their John Boyd Descendants collection that contains well-evidenced identifications of over 100 individuals who genetically descend from John Boyd in exchange for a well-evidenced identification of the paternal grandfather of John Boyd's wife, Leatha Moore.

In certain exemplary embodiments, submitters can earn financial and/or social capital for submitting information that earns at or above a predetermined, threshold, and/or relatively high grade and/or QI. In addition, and/or alternatively, submitters can lose and/or forfeit financial and/or social capital for submitting information that earns at or below a predetermined, threshold, and/or relatively high grade and/or QI.

Likewise, graders can earn financial and/or social capital for appropriately grading submissions and/or the rationale of other graders. In addition, and/or alternatively, graders can lose and/or forfeit financial and/or social capital for inappropriately grading submissions and/or the rationale of other graders.

Storytelling. Storytelling can be viewed as the conveying of [a sequence of] events via words, images, sounds, and/or objects. Elements of storytelling can include:
characters (representations of persons)
events
plot (the order of events in a story)
   chronological
   reverse chronological
   random
   threaded (alternating between multiple simultaneous plots)
   linked (hyperlinked references to further details, related passages, and/or other stories)
   etc.
narrative mode: (the methods the storyteller uses to convey the plot to the audience)
   point of view: (a grammatical descriptor)
      1st person
      2nd person
      3rd person
      multiple person
      alternating person
   voice:
      Stream-of-consciousness voice: provides a (almost always first-person) narrator's perspective by attempting to replicate the thought processes (as opposed to simply the actions and spoken words) of the narrative character)
      Character voice (an identified, relatable, realistic human character who may or may not be involved in the actions of his or her story and who may or may not take a biased approach in the storytelling)
      Epistolary voice (a series of letters and other documents to convey the plot)
      Third-person voices:
         Third-person, subjective (the narrator conveys the thoughts, feelings, opinions, etc. of one or more characters)
         Third-person, objective (“tells a story without describing any character's thoughts, opinions, or feelings; instead it gives an objective, unbiased point of view. This point of view can be described as a “fly on the wall” or “camera lens” approach that can only record the observable actions, but does not interpret these actions or relay what thoughts are going through the minds of the characters”)
         Third-person, omniscient (the most commonly used, this approach tells the story from the point of view of a storyteller who plays no part in the story but knows all the facts, including the characters' thoughts. It sometimes even takes a subjective approach. One advantage of omniscience is that this mode enhances the sense of objective reliability (i.e. truthfulness) of the plot. The third-person omniscient narrator is the most reliable narrator, or in any case, the narrator least capable of being unreliable—although the omniscient narrator can have its own personality, offering judgments and opinions on the behavior of the characters.)
   tense:
      past
      present
      future
   style:
      informal
      formal
      simple
      nuanced
      contextual
      detached
      emotional
      dry
      etc.

Thus, any given story can demonstrate and/or utilize one or more of these elements.

Story Generator. Because storytelling can rely primarily on sequences of events (past, present, and/or future) and/or characters, certain exemplary embodiments can provide an automated family history storytelling tool that can utilize, reference, link to, offer, suggest, present, and/or communicate information regarding one or more relevant events, attributes, individuals, relationships, times, periods, places, and/or regions, as well as supporting evidence (e.g., citations, sources, repositories, and/or eFiles, etc.), arguments, and/or comments, etc.

Certain exemplary embodiments of an automated story generator can craft such information into reasonably worded passages (i.e., phrases, clauses, sentences, paragraphs, sections, chapters, footnotes, endnotes, links, parentheticals, indexes, etc.) and/or even complete stories. For example, given the assertion that John Boyd was born in 1815 in Franklin County, of the state of Virginia, in the United States of America, certain exemplary embodiments can generate a passage and/or sentence along those lines, such as “John Boyd was born in 1815 in Franklin County, Virginia, USA.”

Certain exemplary embodiments of the automated story generator can utilize standard verbs and pronouns to characterize events, attributes, etc. Alternatively, the automated story generator can utilize user selected, machine selected, crowd selected, and/or randomly selected, etc., synonyms of such words and/or phrases to inject variety and interest into its writing style. So instead of stating “John Boyd was born in 1815 in Franklin County, Virginia”, certain exemplary embodiments can generate, offer, store, and/or present the same information in any of several possible manners, such as “John Boyd began his life in 1815 in Franklin County, Virginia”, “The year 1815 witnessed the birth of John Boyd in Franklin County, Virginia”, and/or “John Boyd arrived in 1815, in Franklin County, Virginia”.

Using other machine-known information, such as the name of John's parent(s), the birth sequence of their children, and/or the age and/or proximity of the place in which he was born, etc., certain exemplary embodiments can generate even further variations on one or more given assertions, such as: “In 1815, William and Sarah Boyd welcomed their first child, a son named John Boyd, into their Franklin County home”, “In 1815 at Franklin County, Virginia, a new son named John was born to William and Sarah Boyd”, and/or “In the state of Virginia, in the relatively new county called Franklin, John Boyd entered this world in 1815”, etc.

Thus, given certain family history-related information and/or other relevant information, the automated story generator can create one or more passages that demonstrate and/or utilize one or more story elements, any of which elements can be used-specified, pre-specified, machine-determined, crowd favored, and/or randomly selected.

For a given assertion, event, attribute, etc., the user can supply their own human-generated passage, select from any of multiple relevant machine-generated passages, and/or allow the story generator to randomly select one or more relevant machine-generated and/or human-generated passages. If desired, the user can select a general (e.g., chronological, reverse chronological, etc.) and/or specific ordering for the passages. Thus, potentially based on selected elements for one or more passages and/or for a story, certain exemplary embodiments of the automated story generator can reasonably weave and/or intersperse relevant machine-authored passages (based on machine-known information) with human-authored passages, resulting in a customized and/or customizable story.

As suggested above, certain exemplary embodiments can semi-automatically and/or automatically generate a story written in chronological order, reverse chronological order, and/or even a random order. Alternatively, the story can be written from the perspective of an individual at a particular time in their life, looking back on past events, and explaining events to come. Alternatively, one or more passages and/or a story can be written from the perspective of a contemporaneous observer of the assertion, event, attribute, etc.

General Information. Via certain exemplary embodiments, a generated story need not utilize and/or be limited to assertions that are directly related to a given individual, relationship, event, etc. Instead, the automatic story generator can utilize, link to, and/or weave in general information, such as one or more assertions related to the individual's family, kin, neighbors, society, neighborhood, county, state, country, region, and/or world. If related to a given individual, such general information can paint a richer mosaic of the broader social history, trends, and/or events that likely impacted that individual's life. Such general information can be entered once, linked to, and/or used as desired for any of multiple relevant individuals, families, and/or groups.

General information can relate to the occurrence, timing, and/or location of events and/or trends affecting many, potentially unrelated people, such as wars, famines, epidemics, disasters, mishaps, crimes, disputes, immigration patterns, emigration patterns, and/or the occurrence, timing, and/or location of, e.g.: events, trends, fads, styles, interests, movements, customs, practices, standards, specifications, procedures, rules, law, statutes, discoveries, innovations, revolutions, breakthroughs, changes, expansions, contractions, developments, improvements, progress, advances, failures, declines, set-backs, relapses, regressions, refinements, emergences, evolutions, and/or acquisitions, etc., involving topics of general impact and/or interest, e.g., those fairly classified as: social, economic, environmental, ecological, geophysical, astronomical, meteorological, geological, natural resources, mineralogy, material science, chemistry, physics, scientific, mathematical, engineering, computing, architectural, construction, industrial, manufacturing, energy, technological, agricultural, transportation, business, economics, financial, medical, healthcare, psychological, philosophical, ethical, moral, religious, legal, political, governmental, educational, athletic, sports, recreational, entertainment, pastime, cultural, linguistic, literature, media, theater, musical, culinary, artistic, aesthetic, and/or fashion-oriented, etc.

General information can reference, regard, link to, be provided by, and/or be supported by data and/or information in any known format, such as text, image, audio, video, animation, simulation, etc. Such data and/or information can be obtained from any of a variety of sources, such as Wikipedia, including Wikipedia's featured content and/or items (although its “unfeatured” and/or regular content and/or items can be useful as well). For example, numerous types of data and/or data formatting standards, can be found listed on various Wikipedia pages, each of whose URL begins with “en.wikipedia.org/wiki/”, followed by, e.g.:
for timelines: “List of timelines”
for timeline standards: “Timeline standards”
for events for days of the month: “List of historical anniversaries”
for events for specific days of the month: “August₁₃11” (etc.)
for events for specific years: “1853” (etc.)
for events for specific years and countries: “1853_in_the_United_States” (etc.)
for events for specific years and topics: “1853_in_science” (etc.)
for articles: “Wikipedia:Featured_articles”;
for lists: “Wikipedia:Featured_lists”;
for list candidates: “Wikipedia:Featured_list_candidates”;
for topics: “Wikipedia:Featured_topics”;
for portals: “Portal:Featured_portals”
for “sounds” and/or audio data: “Wikipedia:Featured_sounds”; and/or
for “pictures” and/or image data: “Wikipedia:Featured_pictures”.

General information also can be found on any number of web pages and/or sites, such as the site “timelines.com”, on the page “timelines.com/what-happened-on”, and/or pages for specific dates, such as “timelines.com/what-happened-on/2/11”. Likewise, general information can be found on the site “americanhistory.about.com”, such as on the page “americanhistory.about.com/od/warof1812/a/war-of-1812-timeline.htm”.

General information such as images (e.g., animations, diagrams, drawings, maps, paintings, photos, symbols, etc.), sounds (e.g., music, pronunciation, speeches, spoken Wikipedia, etc.), and/or videos, etc., can be found on various Wikimedia web pages, such as at websites having a URL of “commons.wikimedia.org/wiki/” followed by:
for events: “Category:Events” (e.g., “Category:Tractor_racing”);
for events by year: “Category:Events_by_year” (e.g., “Category: 1854_events”);
etc.

Similarly, photographic data for general information can be found on various Flickr web pages (e.g., “flickr.com/creativecommons/”), such as at websites having a URL of “flickr.com/” followed by, e.g., for photos of Highland County, Virginia in Flickr's creative commons and for which a license is granted to use commercially and to modify, adapt, or build upon: “search/?q=%22%22highland+county%22+virginia%22&1=commderiv&ct=0&mt=all&adv=1”.

Video data for general information can be found on various web pages of video sharing services such as YouTube, Google, Hulu, Vimeo, Viddler, and/or Flickr, etc.

Using General Information. Consider the following examples of the use of general information. Given that John Boyd was born in Virginia in 1815 and died in neighboring Patrick County in 1886, there is a high probability that his life was impacted to some degree by the Civil War. As another example, given that Franklin County in 1815 was primarily populated by farmers who generally favored rich fertile soil found primarily in floodplains, John Boyd probably witnessed the arrival and departure of many neighbors, who came and went seeking better farming opportunities. By way of further example, given that his birthplace and residence was Franklin County, Virginia, which is located in the foothills of the Blue Ridge Mountains, and has been known for many decades for its fondness for and prodigious production of corn-based whiskey (“moonshine”), there is a reasonably high probability that John Boyd was well-acquainted with the manufacture and use of such moonshine. Some of this general information that likely impacted John Boyd probably also impacted his parents William and Sarah, who also were born and resided in Franklin County in the approximately same time period.

Selecting Assertions for Stories. When offering, considering, and/or selecting general information and/or assertions for use in story generation, certain exemplary embodiments can start with and/or rank assertions from most specific to the given individual, family, group, date, time period, and/or place, etc., and expand outwards to those assertions that are less specific and/or apply to a broader region and/or era. Likewise, assertions can be rated, ranked, offered, considered, and/or selected, according to the probability of their general applicability and/or applicability to a given individual, family, group, date, time period, and/or place, etc., with the probability and/or a cut-off and/or threshold for the probability potentially user provided, editable, selectable, gradable, etc.

Although certain exemplary embodiments can function as an automatic biography generator, providing all known assertions regarding a given entity (e.g., individual, family, and/or group, etc.), certain exemplary embodiments can recognize that many non-genealogists prefer hearing, reading, and/or viewing stories that are limited to the most interesting known aspects of the given entity. Thus, via certain exemplary embodiments, one or more assertions can be graded, rated, ranked, selected, and/or proposed, etc., either by one or more users, a crowd, and/or machine, based on the likely level of general interestingness of the assertion(s) and/or on the probable level of interest of the assertion(s) to only researchers of that particular entity. Thus, assertions can be graded and ranked such that only the most highly interesting assertions are most likely to appear in certain stories, while less intriguing assertions are only likely to appear in other, perhaps more biographical stories. A threshold can be set (e.g., by a particular user, selected users, a crowd, and/or machine, etc.) for how interesting an assertion must be to be considered, proposed, and/or presented by the automatic story generator.

For example, for a given collection, a user can specify that only a user-selected number of stories be generated, stored, and/or presented, those stories generated based on the relevant assertions having the highest grades, scores, and/or ratings for interestingness. For example, a user can specify that only the 3 most interesting assertions regarding John Boyd, b. 1815 in Franklin County, Virginia, be included in the story of that John Boyd. As another example, a user can request that only the 4 most interesting assertions from a given collection be included in a story about Franklin County, Virginia in the 1830's. As another example, a user can seek, from all available and/or selected collections, records, and/or data, the 3 most interesting stories for all of Virginia in 1824, as determined by the grades and/or QIs for those stories, their assertions, and/or their submitters, etc. Thus, a user can obtain a customized, dynamically-created, crowd-sourced, historic “newspaper” for any selected individual, family, group, collection, place, region, time, era, event, and/or attribute, etc., that newspaper containing only the most interesting relevant stories as determined by the composite ratings of multiple users. Because new stories can emerge, old stories can be revised, and/or grades and/or QIs can change over time, the contents of such a newspaper likewise can be dynamic (i.e., change over time).

Newspapers and/or stories can be based on and/or filtered by topic, such as stories generally related to topics such as wars, famines, epidemics, disasters, mishaps, crimes, immigration patterns, emigration patterns, and/or topics of general impact and/or interest (such as those previously listed) and/or related to specific aspects thereof (e.g., stories related to the First Battle of Bull Run, stories related to steam locomotives, stories related to bluegrass guitar involving those born in Virginia with the surname of Boyd, etc.).

Story Simulation. In certain exemplary embodiments, a story can be presented using any of written, audible, visual, and/or haptic, etc. media and/or techniques. That is, a given story need not be limited to being read by and/or to a user, but instead can be simulated for and presented to the user via any and/or all available simulation and/or output technologies. For example, applying one or more analyses (such as probabilistic analyses) to specific and/or general assertions and/or facts related to a given individual, one or more vocal, facial, anatomical, mental, psychological, and/or cognitive simulations can be estimated, offered, generated, and/or selected for the given individual, such that the individual's story can be presented, such as in first or third person storytelling “voice”, using that individual's likely body, physical features, clothing, face, voice, accent, phrases, perceptions, beliefs, feelings, memories, and/or perspectives, etc.

Moreover, again applying one or more analyses to specific and/or general assertions and/or facts, certain exemplary embodiments can simulate any known, likely, and/or potential aspect of that individual's environment (e.g., family members, neighbors, acquaintances, home, buildings, terrain, real property, personal property, implements, furniture, foods, clothing, hairstyles, activities, sights, sounds, smells, flavors, and/or haptic sensations (e.g., textures, itches, pains, chills, body movements, etc.), etc.), such that the user can develop a substantial understanding of the likely experiences, perceptions, beliefs, feelings, and/or perspectives, etc., of that individual.

Further, in certain exemplary embodiments, the simulation need not be limited to only selected stories regarding a selected entity (e.g., individual, family, group, etc.), but instead can be generated dynamically in response to one or more user inputs, such as questions, requests, instructions, hints, and/or preferences, etc., which can be provided via any input mechanism, including voice, keyboard, mouse, trackball, joystick, touchpad, retinal tracker, and/or data glove, etc.

For example, assume a user “asks” the story simulator how a given individual “feels” about any relevant topic, such as asking John Boyd, b. 1815 in Franklin County, Virginia for his cognitive perspectives, in 1842, on human slavery. In response, certain exemplary embodiments can utilize, implement, and/or apply:
1. an adaptive natural language user interface, intelligent personal assistant, and/or knowledge navigator (using and/or similar to the Siri “intelligent personal assistant and knowledge navigator” from Apple Inc. of Cupertino, Calif., and/or the “Evi” natural language, artificial intelligence, semantic “answer engine” from Evi Technologies, Ltd. of Cambridge, England, any of which allegedly utilize, e.g., natural dialog, adaptive, machine learning, statistical, probabilistic, multimodal, speech recognition, semantic search, voice control, and/or artificial intelligence, etc., technologies, such as those available from Nuance of Burlington, Mass., one or more of those technologies potentially developed under, an offshoot of, and/or related to the CALO (“Cognitive Assistant that Learns and Organizes”) project of SRI International of Menlo Park, Calif., which itself was sponsored by the PAL (“Personalize Assistant that Learns”) project of DARPA (“Defense Advanced Research Projects Agency”) of Arlington, Va.;
2. an artificial intelligence based, adaptive “discovery engine” reliant, virtual personal assistant for discovering, scraping, and/or presenting digital and/or web content, which learns from use and dynamically personalizes content for that user, such as the iPad app Traplt, available from Traplt Inc. of Palo Alto, Calif.; and/or
3. one or more analyses, such as one or more deterministic, linguistic, semantic, psychological, scientific, medical, structural, finite element, engineering, mathematical, statistical, and/or probabilistic, etc., analyses;

to general and/or specific information, facts, and/or assertions regarding, e.g., said John Boyd, attitudes among Virginians in that time period and/or region regarding the topic, and/or known biases of the user, etc. to simulate a likely answer to the question, in a voice sounding like said John Boyd's reasonably could and/or would have sounded, and/or from his likely viewpoint.

As another example, knowing that a given user has acrophobia (fear of heights and/or falling) and/or that the user therefore probably prefers not to see simulations from the visual and/or haptic perspective of a person in a high place and/or in danger of falling, a simulation can be generated that avoids such perspectives and/or provoking one or more of the user's fears.

As still another example, assuming that a given simulation is presenting an event and/or activity from John Boyd's visual perspective, a user can ask the simulator to move Boyd's body, head, and/or eyes to a different place, so that that visual perspective changes. For example, while simulating the visual perspective of John Boyd riding a horse on his land, the user can direct Boyd to dismount, pick-up an arrowhead exposed in freshly plowed soil, and comment on the arrowhead and/or prior Indian occupants of that land. That is, from the visual, auditory, olfactory, gustatory, chemoreceptive, haptic, mechanoreceptive, thermoreceptive, perceptive, mental, and/or cognitive, etc., perspective of the given individual, the user can “fly-through” and/or direct a simulated event and/or activity, such that the user can experience the event and/or activity, as it likely would and/or could have experienced by the selected individual, except from any of a variety of different locations.

Data Entry and Manipulation. Initially, data entry can be via one or more layouts, such as illustrated in FIG. 4, that are individual-centric and/or family-centric, so that for each family ID there can be a unique family record layout that displays, for example:
a biological “father”, a biological “mother”, a list of children of this biological union, and the biological grandparents for those children; or, more broadly,
each parent, the gender of that parent, a list of children to whom that parent applies, and for each child, the particular role of that parent (e.g., “father”, “mother 1”, “mother 2”, etc.), and that parent's particular relationship (e.g., “biological”, “step”, “foster”, “adoptive”, etc.) with that child.

The one or more layouts can include one or more tiers of tabbed sub-layouts adapted for entering relevant details (the what, when, where, why, and/or how data) about any relevant:
individual
family
group
etc.

One or more additional layouts and/or sub-layouts can be provided for entering, viewing, and/or rendering details about any relevant:
event
attribute
place
time
object
argument
comment
etc.

Still other layouts can be provided for managing evidence, e.g., such as shown in FIGS. 5 and 6, including data and/or meta-data regarding repositories, sources, citations, links, eFiles, arguments, comments, grades, QIs, privileges, subscriptions, etc. Via certain exemplary embodiments, data for events, times, places, attributes, citations, arguments, etc. can be easily entered, edited, and/or assigned to selected individuals, families, and/or groups without re-entry.

Assertions, Sources, & Citations. A collection can present and/or include numerous individuals, each of whom can be related to one or more other individuals, nuclear families, relationships, and/or groups, etc. Each individual and/or relationship can be treated as a record in a corresponding table. Thus, there can be a many-many association between an Individuals table and a Relationships table. Similarly, each individual can relate to many others outside of their family, in any of many roles. Thus, there can be a many-to-many association between records of the Individuals table.

Via other associations, any individual can be linked to various events, each having, e.g., one or more times, places, comments, citations, arguments, and/or grades, etc. For example, data from the Events table and/or Relationships table can describe how one individual relates to others. As another example, birth can relate one individual as the child of another, and initiating employment can relate one individual as the employee, co-worker, and/or supervisor of another.

There can be numerous types, media, and/or formats of sources for potential assertions. A given potential source might provide evidentiary support for any number of potential “atomic” assertions. For example, a given census document might provide evidentiary support for a birth year, relationship type, literacy, occupation, neighbor name, etc.; and/or a particular headstone might provide evidentiary support for a death date, spouse, and/or family affiliation, etc.

Each purported atomic assertion can be evidenced by one or more cited sources. Thus, each assertion, citation, and/or source (and/or link thereto) can be stored as a record in a corresponding table.

There can be a one-to-one, one-to-many, many-to-one, and/or many-to-many relationship between any of the data, records, and/or tables for Users, Individuals, Events, Attributes, Relationships, Times, Places, Sources, Citations, Comments, Arguments, Grades, QI's, Privileges, Subscriptions, and/or Tags, etc.

Potential sources can be recorded, stored, linked to, accessed, presented, and/or rendered digitally, thereby potentially providing an approach for compact and/or secure preservation, rapid search and/or retrieval, and/or ease of communication. When a potential source is identified and/or collected, it can be logged in such a manner that it can be easily retrieved and/or displayed when desired. When genealogical information is recorded, linked to, stored, and/or rendered, each purported assertion can be clearly associated with each of its sources via one or more unique citations. To facilitate this associating and/or linking, a database can be provided that includes a Source Table for storing general information about each source, and a Citation Table for storing detailed information about each citation. Information about each source can be stored as a separate record across any desired fields of the Source Table, and similarly, information about each citation can be stored as a separate record across any desired fields of the Citation Table. In the database, each source record can include its own unique identifier, and each citation record can include its own unique identifier.

Because certain exemplary embodiments of the database can present the details of each of its records, the corresponding record identifiers need have no inherent “intelligence”. That is, they need not facially convey anything other than their unique identity. Each record identifier can be generated sequentially. An exemplary source identifier might be S0001, which can allow for 9,999 potential sources. An exemplary citation identifier might be C00001, which can allow for 99,999 citations. Additional leading zeros can be added at any time desired and/or needed for expansion.

Reports. Certain exemplary embodiments can specify, design, create, present, and/or render one or more predetermined, user-selected, and/or user-customized reports, charts, sheets, and/or trees (“reports”) that can list, present, and/or render relevant data and/or records. Any number of potential types of reports are possible, including, for example:
All-In-One: can show all individuals in a collection;
Ancestor: can show a predetermined number of generations of an individual's ancestors extending, often in tree or fan form, rightward, leftward, downward, upward, and/or radially from the individual;
Ancestor Narrative: can show an ancestor's story and/or a narrative describing the ancestor, their events, and/or their attributes;
Calendar;
Cascading Pedigree: can show one or more pedigree charts showing a person's ancestry;
Citations;
Convergent;
Correspondence Log;
Descendant: can show descendants of an individual either as a fan chart or a tree, where the fan chart shows the first generation as the center circle and each generation of descendants branching outward in a larger circle, half-circle or quarter-circle, and the tree shows shows the starting individual at the top and descendants branching off downward;
Descendant Narrative;
Everyone (all in one);
Family Group: can show a succinct summary of a couple and their children, such as dates and places of birth, baptism, marriage, death and burial, and/or source citations;
Fan: can show the starting individual in the center with each successive generation of ancestors or descendants appearing in a circle moving outward from the center;
Genealogy: can show the ancestors or descendants of the starting individual;
Hourglass: can show a starting individual in the middle with parents and grandchildren above and children and grandchildren below;
Index of Individuals: can list individuals, e.g., by last name, in alphabetical order;
Index of Occupations;
Index of Places;
Index of Times;
Individual Narrative: can show an individual's story and/or a narrative describing the individual, their events, and/or their attributes;
Kinship: can show an alphabetical list of names and each person's relationship to a selected individual;
Life Bar Chart: can show important milestones over the course of in individual's lifetime;
Map: can show specific and/or general events across a geographic area (e.g., neighborhood, county, state, country, world, etc.);
Media: can show a list of source material, links, and/or eFiles, etc.;
NGS Quarterly: can show an individual's descendants arranged by generation, using an alternative numbering system to the Register report;
Outline Ancestors: can show a person's ancestors in a hierarchical outline format, where each successive generation can be indented;
Outline Descendants: can show a person's descendants in a hierarchical outline format, where each successive generation can be indented;
Pedigree (see Ancestor)
Places;
Register: can show an individual's descendants arranged by generation;
Research Tasks;
Research Log;
Sources;
Timeline: can show, using bars, each individual's life span so you quickly can see who was living when and whose lifetimes overlapped; can show specific and/or general events;
Tiny Tafel: can show, for each surname in an individual's ancestry, the Soundex or other phonetic code, the range of years when individuals with that name were born, and/or where the earliest and/or most recent births occurred; and/or
Waterfall: can show a descendant tree chart with descendants cascading down from upper left to lower right;
etc.

In certain exemplary embodiments, nearly any narrative report can include:
full details of aunts, uncles, and/or cousins, plus their descendants;
indirect branches (e.g., relations of people who married into the subject individual's family);
unconnected individuals;
the relationship to the subject person of each reported individual (e.g., “first cousin by marriage, once removed”).
thumbnail pictures of individuals;
unknown names;
the upper/lower cases of names in a standard form (e.g., “John Boyd”);
ages of individuals at the times of events; and/or
dates in a standard format (e.g., “25 December 1832” or “December 25, 1832”);
events sorted by time, place, type, etc.;
etc.

Numbering systems. Certain exemplary embodiments can employ one or more genealogical numbering systems for systematically and/or numerically identifying, distinguishing, and/or presenting individuals, families, and/or groups, etc. For example, Ahnentafel Numbering can be used in pedigree charts and/or ancestor-oriented genealogy reports, allow for numbering of ancestors beginning with a descendent, and/or give unique derived numbers to each person. The Register System can use common numerals (1, 2, 3, 4) and Roman numerals (i, ii, iii, iv), and/or group each generation separately. The National Genealogical Society Quarterly (“NGSQ”) system (a.k.a., the “Modified Register System” can assign a number to every child, regardless of whether that child has descendants.

Avoiding Issues. Certain exemplary embodiments can offer, provide, and/or implement various approaches to avoid, prevent, and/or minimize the effect of various potential issues.

Malware. For example, to avoid and/or reduce the transmission of malware, certain exemplary embodiments can quarantine and/or review submitted eFiles and/or other electronic documents to verify they appear to be free of malware. Similarly, any submitted link can be quarantined and/or review to verify it does not point to a malicious site, page, and/or file.

Breach of Privacy. To avoid, prevent, and/or minimize issues related to breach of privacy and/or defamation, certain exemplary embodiments can restrain, limit, discourage, disallow, prevent, refuse, and/or reduce submission of information related to living individuals. For example, if a submission includes information about someone who was born less than 120 years ago, but who is not indicated as deceased, certain exemplary embodiments can assume that individual is living, and require their authenticated authorization prior to entering, posting, and/or providing a subscription to the submission.

An authenticated authorization can be provided via, e.g.:
1. setting-up a user account in that individual's name;
2. associating that user account with a valid credit card number, debit card number, driver's license, and/or other government-validated identification issued in that individual's name;
3. sending a notification of the proposed submission to that individual's registered e-mail account, the notification including a link the individual must click to authorize the submission;
4. receiving a response from the provided link within a predetermined time period; and/or
5. requiring entry of the user's account password;
etc.

Even when an individual consents to publication of information about them, certain exemplary embodiments can provide one or more notices to that individual regarding, e.g.: the general risk the published information could impose on that individual's privacy; when someone accesses, subscribes to, and/or uses that individual's information; and/or how to restrict access to that information; etc.

In certain exemplary embodiments, when information is submitted and/or entered regarding an actual and/or presumed living individual, “ownership” of that information can immediately pass to the living individual and/or an administrator, and the submitter can be prevented and/or limited in their ability to allow others to access that information until consent and/or authenticated authorization is provided by the living individual to allow the submitter to control access to the information.

Certain exemplary embodiments can refuse and/or limit the ability to submit and/or enter information about minors, potentially requiring consent and/or authenticated authorization from a parent and/or guardian before sharing, publication, and/or subscription, etc.

Privacy also can be of some level of concern for deceased individuals, particularly from the perspective of their descendants, next of kin, loved ones, and/or fans, etc. For instance, disclosing a embarrassing incident in the life of someone who has recently departed might not be illegal and/or legally actionable, but nevertheless might be considered to be in poor taste, particular in the eyes of those who hold that deceased person in high regard. Yet disclosing similar information for someone who has been dead for a substantial period of time, such as, e.g., at least 20, 50, and/or 100 years, might not evoke nearly as strong of a negative reaction, and possibly even a positive reaction, even among that individual's descendants.

Thus, certain exemplary embodiments can provide varying levels of privacy protection for deceased individuals, potentially depending on how long that individual has been deceased. For example, certain exemplary embodiments can restrain, limit, discourage, disallow, prevent, refuse, and/or reduce submission of information related to individuals indicated and/or determined to have been deceased less than a predetermined amount of time. By way of further example, those who have been dead for 135 years can be assumed to have died by a predetermined maximum potential human age, such as 120, and thus have been dead for at least 15 years. But absent satisfactory evidence that the individual has been dead for more than a predetermined number of years, e.g., 20 years, the system can refuse the submission. For individuals determined to have been deceased longer, such as from 20 to 50 years, the system can require quarantine and/or review of the submission to reduce, minimize, and/or eliminate the likelihood that potentially problematic, inflammatory, defamatory, offensive, and/or privacy breaching information will be entered, posted, and/or rendered to other users of the system. For individuals determined to have been deceased still longer, such as over 50 years, the system can rely on grading and/or reports from users to the administrators for notification of potentially problematic, inflammatory, defamatory, offensive, and/or privacy breaching information.

Certain exemplary embodiments can restrain, limit, discourage, disallow, prevent, refuse, and/or reduce submission of information depending on, e.g., one or more grades, QIs, and/or trust metrics, etc., associated with the submitter. For example, submissions from new submitters might be delayed until they can be reviewed to reduce, minimize, and/or eliminate the likelihood that they contain potentially problematic, inflammatory, defamatory, offensive, and/or privacy breaching information. As that submitter's grades, QIs, and/or trust metrics grow and/or improve, reviews and/or delays can be reduced and/or eliminated.

In certain exemplary embodiments, users can be motivated to contribute by receiving attribution, compensation, bounties, feedback, grades, user ratings, and/or usage/access credits in exchange for their input, submissions, feedback, and/or opinions, and/or the opportunity to advertise themselves and/or their firm, etc. For example, in certain exemplary embodiments, submitters can earn compensation, e.g., in the form of acclaim, points, and/or money, in response to submitting and/or entering information that complies with one or more submission requirements, earns one or more relatively high scores (e.g., grades, QIs, and/or trust metrics, etc.), obtains a predetermined number of subscribers, and/or otherwise is illustrative of trustworthy research work and/or one or more desired behaviors.

To discourage substantial infractions, untrustworthy research work, low scores, and/or other undesired behaviors, certain exemplary embodiments can reduce, discount, and/or withhold compensation due to a submitter in response to substantial infractions, untrustworthy research work, low scores, and/or other undesired behaviors.

Similarly, certain exemplary embodiments can require submitters to post some form of bond and/or indemnity prior to submitting and/or entering information, such that substantial infractions, untrustworthy research work, low scores, and/or other undesired behaviors during a predetermined time period can trigger payment to the system of the amount of the bond and/or indemnity.

Likewise, certain exemplary embodiments can place a predetermined portion and/or amount of compensation due to a submitter into escrow, to be released and/or made available to the submitter after one or more predetermined criteria are met, such as after a predetermined time has passed and substantial infractions, untrustworthy research work, low scores, and/or other undesired behaviors are not discovered and/or reported regarding that submitter and/or that submitter's submissions.

Trolling and/or Bullying. Certain exemplary embodiments can restrain, limit, discourage, disallow, prevent, refuse, and/or reduce the submission and/or entry of information that tends to inflame, embarrass, and/or abuse others and/or their submissions. For example, certain exemplary embodiments can utilize a reporting and/or scoring mechanism (e.g., grades, QIs, and/or trust metrics) to identify those attempting to and/or actually engaging in inappropriate behaviors with regard to the system and/or its users, such that an appropriate response can be invoked. Via avoiding such circumscribed, off-limits, and/or socially discouraged behaviors, certain exemplary embodiments can reward submitters and/or users. Likewise, certain exemplary embodiments can punish, penalize, and/or otherwise discourage submitters and/or users from engaging in such behaviors.

Using Grades and/or QIs. Certain exemplary embodiments can manually, semi-automatically, and/or automatically apply statistical and/or other mathematical techniques to one or more family history related information items, such as grades and/or QIs. For example, certain exemplary embodiments can determine statistics (such as range, mean, average, median, mode, variance, standard deviation, confidence interval, etc.) to determine a “best” and/or “average” grade for a given, found, sampled, selected, and/or predetermined population of family history related information.

For example, certain exemplary embodiments can manually, semi-automatically, and/or automatically calculate, obtain, identify, provide, report, and/or store, a best and/or highest (or worst or lowest) scoring collection, record, submission, assertion, argument, submitter, and/or grader, etc., and/or corresponding grade from among a given, found, sampled, selected, and/or predetermined population of collections, records, submissions, assertions, arguments, submitters, and/or graders, etc. As another example, a given, found, sampled, selected, and/or predetermined population of collections, records, submissions, assertions, arguments, submitter, and/or grader, etc., can be ranked according to, e.g., the grades of one or more of its assertions, its highest and or best-scoring submissions, its average argument grade, etc.

Certain exemplary embodiments can manually, semi-automatically, and/or automatically create a composite grade and/or QI from the grades of multiple family history related information, such as one or more collections, records, data, submissions, assertions, etc. associated with a given entity, such as a user, individual, group, event, place, time, source, submitter, and/or grader, etc.

For example, by compositing the grades of each assertion a submitter submits in a given time period to arrive at a cumulative, average, and/or weighted average score, and comparing such cumulative scores between submitters, an indication of which submitters are submitting the most and/or least impactful work can be determined and/or utilized for purposes such as benchmarking, valuation, acquisition, evaluation, education, recommendation, compensation, etc.

Certain exemplary embodiments can manually, semi-automatically, and/or automatically receive, suggest, and/or apply, potentially on a tentative and/or test basis, new and/or modified grading criteria and/or QIs, and/or determine their impact (score, value, and/or risk, etc.) on an identified set of graded information.

In certain exemplary embodiments, QIs can be compounded, mixed, combined, complexed, blended, conglomerated, synthesized, composited, and/or aggregated (e.g., by combining the QIs in a manner that the result reflects both the number of QIs and the magnitude of each QI; multiplying each QI by a grader-selected weight that indicates the value they assign to an associated family history related information and/or input (e.g., submission, comment, eFile, etc.); etc.), such as to form a “trust metric” regarding family history related information provided by one or more predetermined and/or selected users and/or associated with the respective QIs. Thus, a user might elect to trust and/or rely on family history related information associated with one or more submitters who has earned one or more high trust metrics.

In certain exemplary embodiments, a trust metric can be used as, and/or to imply and/or create, a weighting to be applied to an associated one or more user's one or more predetermined and/or selected QIs. Thus, for example, a user could build synthesized QIs that reflect (potentially composite) trust metric-weighted QIs of one or more predetermined and/or selected users. As the number of predetermined and/or selected users grows, the composite QIs can shift from reflecting an “expert panel” to “crowd-sourced” QIs. That is, rather than representing a relatively small group of trustworthy submitters, a trust metric-based QI can represent and/or be related to, a relatively large number, or crowd, of submitters.

In certain exemplary embodiments, a user can propose that a QI and/or related field be modified, added, excluded, and/or deleted from the system and/or any default QIs, and/or simply be considered for application against one or more particular inputs.

Teamwork. In certain exemplary embodiments, one or more users can form competitive teams. Such teams can compete with one or more other teams, such as to earn the highest score, QI, and/or trust metric, etc. For example, teams can compete to see which can earn a composite score, such as for grading family history related information, that best predicts the overall composite score for that information. Similarly, teams can compete to see which can first obtain and submit a specific evidentiary document or eFile, which can earn the highest score for evidencing, arguing, and/or “proving” a given assertion, which can submit the highest rated story about a designated topic, etc. Teams can compete for, e.g., compensation, usage credits, prizes, lottery admission, recognition, donations made in their name to a system- and/or team-designated charity, etc.

Scoring. Users can chose what specific items (submissions, grades, etc.) to score, can be asked by the system to score specific items, and/or can be assigned by the system to score specific items. Such assignments can expire after a predetermined time. A submission can be automatically scored, scored in the event another user volunteers to do so, and/or can scored upon the request of the submitter, potentially by submitter-selected scorers and/or at the cost of user credits.

The earning of user credits can be dependent upon the number of submissions, scores, and/or grades, etc., a user submits, the length of time the user has participated, how often the user logs in, the grades earned by the user, and/or the amount of a user's participation in the system, such as in the system's judicial process.

Judicial Process. In certain exemplary embodiments, a judicial process can allow for self-regulation by the system's users to help ensure that the system remains reasonably objective and/or fair while helping to ensure that submissions stay within system guidelines. The judicial process can allow users to decide not only what is reported, but also whether or not it should be removed from the system. The judicial process can work in separate phases to prevent manipulation. The reporting phase, which is where a user notifies the system that he/she has found a submission that is believed to be in violation; the arraignment phase, which is where users can vote on the reported submission to determine if the alleged violation should be decided by a jury; and/or the trial phase, which is where users who are members of a jury can vote whether the submission should be deleted.

Tracking Usage. Certain exemplary embodiments can track usage of the system. For example, certain exemplary embodiments can track what family history related information is searched, viewed, graded, and/or commented upon, and/or to what extent. As another example, certain exemplary embodiments can track usage by, e.g., activity, use, user, submission, collection, assertion, individual, family, group, relationship, time, timespan, place, area, object, event, attribute, repository, source, citation, link, digital file, comment, argument, tag, grade, quality indicator, authority, privilege, subscription, account, etc., and/or values, terms, and/or phrases appearing in the family history related information and/or associated metadata.

Advertisements. Building on this tracking ability, certain exemplary embodiments can determine, match, target, provide, serve, and/or present one or more advertisements to users of the system, based at least in part on the family history related information provided by and/or to that user, the usage pattern and/or profile associate with that user and/or others (based on metrics such as exposures, impressions, clicks and/or taps, click-through-rate and/or tap-through-rate, unique visits, average time spent, pages viewed, views and/or views per visit, interactions (e.g., videos viewed, games played, etc.), conversions, subscriptions, and/or downloads, etc.), that usage profile potentially augmented by usage information for that user provided by one or more other usage tracking systems, such as that of one or more internet search engines, retailers, financial services, information and/or marketing services, web services, and/or web sites, etc., and/or one or more user-related parameters, such as location, demographics (e.g., age, gender, and/or income, etc.), passions (e.g., genealogy, mineral collecting, and/or gardening, etc.), genre interests (e.g., blues, classical, house, etc.), device (e.g., IPHONE, IPAD, BLACKBERRY, etc.), network technology (e.g., WIFI, 3G, CDMA, LTE, EDGE, and/or WIMAX, etc.).

For example, for users who search for, view, grade, and/or comment upon, etc., family history related information regarding and/or related to “baseball”, certain exemplary embodiments can provide one or more advertisements that are related to Major League Baseball, baseball related products and/or services, complementary products and/or services, and/or competitive products and/or services, etc.

As another example, certain exemplary embodiments can recognize that a given user tends to focus their activities on family history related information pertaining to a particular topic; e.g. a particular event, attribute, place, and/or activity, etc., and has a certain usage pattern with regard to, and/or provided by, a particular internet search engine (such as GOOGLE, BING, YAHOO, BAIDU, and/or DOGPILE, etc.), a particular retailer (such as AMAZON, ZAPPOS, and/or WALMART, etc.), a particular financial service (such as VISA, WESTERN UNION, and/or E-TRADE, etc.), a particular information and/or marketing service (such as EXPERIAN, EPSILON, ACXIOM, TARGETBASE, ALLANT, ADWORDS by GOOGLE, and/or IAD by APPLE, etc.), a particular web site and/or service (such as WIKIPEDIA, TRAVELOCITY, FACEBOOK, TWITTER, YOUTUBE, LINKEDIN, CRAIGSLIST, FLICKR, CNN, and/or the ITUNES store, etc.), financial transactions, service providers, and/or product purchases, etc. Via certain exemplary embodiments, that topic and/or usage pattern information can be used to cause one or more particular advertisements to be selected, targeted, presented, and/or presented with increased frequency, to the user. In certain exemplary embodiments, one or more advertisements can be presented to the user in one or more predetermined formats, such as text, graphics, audio, video, animation, static, dynamic, rich media, and/or interactive, etc.

As yet another example, certain exemplary embodiments can track the “popularity” of family history related information, e.g., pertaining to one or more topics. The service of providing advertisements to users can be “sold” to advertisers based on such popularity. That is, for example, the higher the popularity of the family history related information, the higher the price for presenting a given advertisement to any user of that family history related information.

Hierarchical structures and/or processors. Certain exemplary embodiments can provide one or more automatically navigable and/or user-navigable hierarchical structures that can comprise content such as, e.g., one or more activities, uses, users, submissions, collections, assertions, individuals, families, groups, relationships, times, timespans, places, areas, objects, events, attributes, repositories, sources, citations, links, digital files, stories, simulations, decisions, opinions, assertions, arguments, comments, notes, characteristics, designations, tags, categories, realms, domains, populations, samples, rules, statistics, probabilities, rates, metrics, grades, scores, quality indicators, authorities, privileges, subscriptions, accounts, activities, profiles, usage credits, advertisers, advertisements, etc., and/or values, terms, and/or phrases appearing in the family history related information and/or associated metadata, etc. Such content can be organized in any manner desired, such as, e.g., alphabetically, alphabetically, topically, chronologically, ascending, descending, randomly, and/or user-selectably, etc. Such structures can be created and/or used as explained in U.S. patent application Ser. No. 12/500,758 (attorney docket 1007-023), filed 10 Jul. 2009, which is incorporated herein by reference in its entirety, and is incorporated particularly for its explanation of hierarchies, its hierarchical processor, its hierarchical processing (e.g., member movement, member labels, member expansion and contraction, member data, etc.), its presentation of alternative views, its use of external data sources and/or targets, its examples, its definitions, and its figures.

For example, a user can navigate a hierarchical outline and/or tree to see and/or select one or more desired individuals and/or associated descendants and/or ancestors. As another example, certain exemplary embodiments can provide one or more users with the ability to manually associate a desired digital file with a given event. For example, once one or more desired digital file has been selected, a user can navigate a hierarchical structure to locate, identify, and/or select one or more desired individuals, events, and/or attributes to associate therewith.

Certain exemplary embodiments can provide one or more systems, machines, devices, manufactures, circuits, and/or user interfaces adapted for, and/or a methods and/or machine-readable mediums comprising one or more machine-implementable instructions for, one or more activities that can comprise managing family history information, which can include, for example, manually, semi-automatically, and/or automatically:
soliciting, determining, obtaining, storing, identifying, analyzing, explaining, grading, evaluating, presenting, and/or communicating a family-history related assertion;
soliciting, determining, obtaining, storing, identifying, analyzing, explaining, grading, evaluating, presenting, and/or communicating a source of the family-history related assertion;
soliciting, determining, obtaining, storing, identifying, analyzing, explaining, grading, evaluating, presenting, and/or communicating a proof of the family-history related assertion;
soliciting, determining, obtaining, storing, identifying, analyzing, explaining, grading, evaluating, presenting, and/or communicating one or more quality indicators, e.g., one or more considerations, influences, metrics, factors, elements, parameters, variables, points, characteristics, strengths, weaknesses, benefits, flaws, vulnerabilities, conflicts, evidence, reasons, and/or risks, etc., associated with the family history-related assertion, the source, and/or the proof;
researching, targeting, finding, and/or logging potential family members (and/or other potentially relevant people) and/or potential details of their lives;
asserting, evidencing, arguing, and/or presenting relevant alleged and/or proven facts; and/or
storytelling, crafting, drafting, and/or sharing highly engaging fact-based narrative and/or descriptive accounts of at least a portion of the lives of family members;
etc.

Certain exemplary embodiments can manually, semi-automatically, and/or automatically seek, determine, find, gather, store, post, manipulate, analyze, correlate, assign, graph, plot, chart, report, output, and/or provide further information regarding any family history related information.

Note that certain exemplary embodiments are not limited to family history related information, but instead can be expanded, adapted, and/or utilized to manage any history related information, any event related information, and/or any individual related information, etc.

Note that any attached documents are an integral part of this application and are incorporated by reference herein in their entirety.

FIG. 1 is a block diagram of an exemplary embodiment of a system 1000, which can comprise any number of user information devices, such as a desktop computer 1100, laptop computer 1200, smartphone and/or PDA 1300, etc. Any of user information devices 1100, 1200, 1300 can comprise a database management system client 1120, 1220, 1320 and/or a family history related information processor 1140, 1240, 1340. Any of user information devices 1100, 1200, 1300 can be communicatively coupled via a network 1400 to a server 1500, which can comprise a database management system server 1520, a family history related information processor 1560, and/or a user and/or administrator interface 1580. Server 1500 can be communicatively coupled to one or more databases 1540, 1640. Likewise, server 1600 can be communicatively coupled to one or more servers 1700, 1800, any of which can comprise a database management system and/or file management system 1720, 1820, respectively, and/or can be communicatively coupled to one or more databases 1740, 1840.

FIG. 2 is a block diagram of an exemplary embodiment of an information device 2000, which in certain operative embodiments can comprise, for example, user information device 1100, 1200, and/or 1300, and/or server 1500, 1700, and/or 1800 of FIG. 1. Information device 2000 can comprise any of numerous transform circuits, which can be formed via any of numerous communicatively-, electrically-, magnetically-, optically-, fluidically-, and/or mechanically-coupled physical components, such as for example, one or more network interfaces 2100, one or more processors 2200, one or more memories 2300 containing instructions 2400, one or more input/output (I/O) devices 2500, and/or one or more user interfaces 2600 coupled to I/O device 2500, etc.

In certain exemplary embodiments, via one or more user interfaces 2600, such as a graphical user interface, an information device can provide a rendering of family history related information to a user.

FIG. 3 is a flowchart of an exemplary embodiment of a method 3000. At activity 3100, family history related information can be obtained. At activity 3200, family history related information can be submitted. At activity 3300, a family history related database can be populated using the family history related information. At activity 3400, any portion of the family history related information can be found via a search and/or navigation of the database.

At activity 3500, one or more quality indicator and/or grading rules can be specified. At activity 3600, one or more grades can be specified. At activity 3700, one or more quality indicators can be obtained. At activity 3800, one or more scores can be evaluated.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
accessible—capable of being contacted by an information device to perform a specific function.
activity—an action, act, step, and/or process or portion thereof.
adapted to—suitable, fit, and/or capable of performing a specified function.
adjust—to change, modify, adapt, and/or alter so as to match, fit, adapt, conform, and/or be in a more effective state.
advertisement—a notice, such as a paid announcement, designed to attract public attention and/or patronage.
all—every one of a set.
alternative—a substitute and/or different entity.
analyze—to review, study, examine, evaluate, and/or consider in detail and/or to subject to an analysis in order to discover essential features and/or meaning.
and/or—either in conjunction with or in alternative to.
apparatus—an appliance or device for a particular purpose
apply—to implement and/or to put to, on, and/or into action, use, and/or service.
associate—to join, accompany, connect together, and/or relate.
at least one—not less than one, and possibly more than one.
attribute—a descriptor.
automatic—performed via an information device in a manner essentially independent of influence and/or control by a user. For example, an automatic light switch can turn on upon “seeing” a person in its “view”, without the person manually operating the light switch.
based—being derived from, conditional upon, and/or dependent upon.
bit-map—a set of bits that represents a graphic image, where each bit and/or group of bits corresponds to a pixel in the image. Optical scanners and fax machines often convert text and/or pictures into bitmaps.
Boolean logic—a complete system for logical operations.
by—via and/or with the use or help of.
can—is capable of, in at least some embodiments.
cause—to bring about, provoke, precipitate, produce, elicit, be the reason for, result in, and/or effect.
character-encoded—transformed into one or more computer-readable symbols via a computer-implemented character encoding system such as ASCII, Unicode, UTF-8, UTF-16, UTF-32, EBCDIC, ISO 8859, ISO 2022, Windows-1250 through 1258, Mac OS Roman, JIS X 0208, JIS X 0213, Guobiao, BigS, HKSCS, KS X 1001, ANSEL, HTML, XML, etc.
circuit—a physical system comprising, depending on context: an electrically conductive pathway, an information transmission mechanism, and/or a communications connection, the pathway, mechanism, and/or connection established via a switching device (such as a switch, relay, transistor, and/or logic gate, etc.); and/or an electrically conductive pathway, an information transmission mechanism, and/or a communications connection, the pathway, mechanism, and/or connection established across two or more switching devices comprised by a network and between corresponding end systems connected to, but not comprised by the network.
claim—(n) an assertion of a right to and/or responsibility for something; (v) to assert a right to and/or responsibility for something.
combine—to join, unite, mix, and/or blend.
common—same and/or single.
composite—compound and/or made up of discrete components.
comprised by—an indication that a first thing is included in, on, by, etc., a second thing, the second thing potentially including other things. Thus, it can be said that the second thing “comprises” the first thing, that is, includes, but is not limited to, the first thing.
comprising—including but not limited to.
compute—to calculate, estimate, determine, and/or ascertain via a processor.
configure—to make suitable or fit for a specific use or situation.
containing—including but not limited to.
content—a substance and/or substantive portion of stored data and/or a stored and/or written work and/or electronic file.
convert—to transform, adapt, and/or change.
corresponding—related, associated, accompanying, similar in purpose and/or position, conforming in every respect, and/or equivalent and/or agreeing in amount, quantity, magnitude, quality, and/or degree.
corroborate—to evidence, explain, support, justify, and/or validate.
count—(n.) a number reached by counting and/or a defined quantity; (v.) to increment, typically by one and beginning at zero.
create—to bring into being.
crowd-source—to seek and/or receive input and/or feedback based on an open call to a group of people, such as those who are likely fit to perform relevant tasks, solve pertinent problems, and/or contribute meaningful and/or innovative ideas.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta-data to describe the properties of the data structure. Examples of data structures can include: array, dictionary, graph, hash, heap, linked list, matrix, object, queue, ring, stack, tree, and/or vector.
database—one or more structured sets of persistent data, usually associated with software to update and query the data. A simple database might be a single file containing many records, each of which is structured using the same set of fields. A database can comprise one or more tables.
decrement—to decrease in size and/or count by one element at a time.
define—to establish the meaning, relationship, outline, form, and/or structure of; and/or to precisely and/or distinctly describe and/or specify.
definition—a formal statement of the meaning and/or significance of a word, phrase, morpheme, morpheme combination, and/or other linguistic unit, etc.
derive—to obtain via determining, calculating, and/or looking-up.
designation—a characterization.
determine—to find out, obtain, calculate, decide, deduce, ascertain, and/or come to a decision, typically by investigation, reasoning, and/or calculation.
device—a machine, manufacture, and/or collection thereof.
digitally—electronically and/or optically processed, stored, and/or transmitted, using one or more non-analog and/or discrete techniques.
does not—fails to perform in a predetermined and/or specified manner.
each—every one of a group considered individually.
electronic—digitally processed, stored, and/or transmitted.
encode—to convert data by the use of a code, frequently one consisting of binary numbers, in such a manner that reconversion to the original form is possible. Alternatively, to append redundant check symbols to a message for the purpose of generating an error detection and/or correction code.
entity—at least one person, role, team, group, and/or organization.
estimate—(n) a calculated value approximating an actual value; (v) to calculate and/or determine approximately and/or tentatively.
event—an occurrence and/or happening.
file repository—computer-addressable location and/or memory where a set of data, such as related data, is stored.
filter—to screen and/or narrow.
find—to discover, detect, locate, identify, obtain, ascertain, and/or determine.
first—an initial entity in an ordering of entities and/or immediately preceding the second in an ordering.
for—with a purpose of.
form—to make, build, compose, construct, produce, generate, and/or create.
format—to arrange for storage or display.
from—used to indicate a source, origin, and/or location thereof.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
human-machine interface—hardware and/or software adapted to render information to a user and/or receive information from the user; and/or a user interface.
identify—to specify, indicate, communicate, describe, recognize, detect, and/or establish the identity, origin, nature, and/or definitive characteristics of
image—an at least two-dimensional representation of an entity and/or phenomenon.
implement—to accomplishing some aim and/or execute some order.
including—including but not limited to.
increment—to increase in size and/or count by one element at a time.
indicate—to show, mark, signal, signify, denote, evidence, evince, manifest, declare, enunciate, specify, explain, exhibit, present, reveal, disclose, and/or display.
indicator—one or more signs, tokens, symbols, signals, devices, and/or substance that indicates.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as an iPhone-like and/or Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any device adapted to provide input to, and/or receive output from, an information device. Examples can include an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, switch, relay, haptic device, vibrator, tactile simulator, and/or tactile pad, potentially including a port to which an I/O device can be attached or connected.
instructions—directions, which can be implemented as hardware, firmware, and/or software, the directions adapted to perform a particular operation and/or function via creation and/or maintenance of a predetermined physical circuit.
into—to a condition, state, and/or form of; and/or toward, in the direction of, and/or to the inside of.
iteratively—repetitively and/or repeatedly.
link—(n) an activateable connection to a: web page, location in/on a web page, file, location in a file, database, databases record, database field, location in a database, and/or other computer-readable resource; (v) to provide and/or activate such a connection.
list—a sequence of information.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. . Thus, each electronic logic gate typically requires power so that it can source and/or sink currents to achieve the correct output voltage. Typically, machine-implementable instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine-implementable instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine-implementable instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine-implementable instructions—directions adapted to cause a machine, such as an information device, to perform one or more particular activities, operations, and/or functions via forming a particular physical circuit. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied and/or encoded as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain one or more machine-implementable instructions, data, and/or information. Examples include a memory device, punch card, player-piano scroll, etc.
maximum—a greatest extent.
may—is allowed and/or permitted to, in at least some embodiments.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
meta-data—meta-content and/or data about one or more instances of predetermined data, such as data regarding, describing, and/or characterizing: when the predetermined data was created and/or revised; its author and/or owner; its size, storage, context, purpose, classification, domain, realm, attribute, and/or designation, etc.; etc.
method—one or more acts that are performed upon subject matter to be transformed to a different state or thing and/or are tied to a particular apparatus, said one or more acts not a fundamental principal and not pre-empting all uses of a fundamental principal.
metric—a calculated and/or measured value.
more—a quantifier meaning greater in size, amount, extent, and/or degree.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, radio, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, 3G, 4G, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, Ethernet card, cable modem, digital subscriber line interface, bridge, hub, router, or other similar device, software to manage such a device, and/or software to provide a function of such a device.
new—having been made, defined, determined, entered, and/or coming into existence relatively recently as compared to something else.
no—an absence of and/or lacking any.
number—a count and/or quantity.
obtain—to receive, get, take possession of, procure, acquire, calculate, determine, and/or compute.
occur—to happen, take place, exist, be located, and/or come about.
one—being or amounting to a single unit, individual, and/or entire thing, item, and/or object.
or—used to indicate alternatives, typically appearing only before the last item in a group of alternative items.
packet—a generic term for a bundle of data organized in a specific way for transmission, such as within and/or across a network, such as a digital packet-switching network, and comprising the data to be transmitted and certain control information, such as a destination address.
parse—to analyze by first segregating, dividing, dissecting, breaking-down, and/or taking apart.
pattern—one or more predetermined configurations, sequences, and/or arrangements.
perceptible—capable of being perceived by the human senses.
phrase—one or more words, acronyms, etc.
physical—tangible, real, and/or actual.
physically—existing, happening, occurring, acting, and/or operating in a manner that is tangible, real, and/or actual.
plurality—the state of being plural and/or more than one.
populate—to supply with data.
portion—a part, component, section, percentage, ratio, and/or quantity that is less than a larger whole.
predetermined—determined, decided, obtained, calculated, and/or established in advance.
present—to show, display, render, illuminate, and/or indicate, etc.
prioritize—to present elements of a set one after the other in order of importance.
probability—a quantitative representation of a likelihood of an occurrence.
process—v. to put data and/or information through the activities of a predetermined procedure, which can involve transferring, merging, sorting, transforming, and/or computing (i.e., arithmetic operations or logical operations).
processor—a machine that utilizes hardware, firmware, and/or software and is physically adaptable to perform, via Boolean logic operating on a plurality of logic gates that form particular physical circuits, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
project—to calculate, estimate, or predict.
provide—to furnish, supply, give, convey, send, and/or make available.
quality indicator—a computer-implementable mechanism configured to assess and/or indicate one or more potential quality-related and/or value-related considerations, influences, metrics, factors, elements, parameters, variables, points, characteristics, strengths, weaknesses, benefits, flaws, vulnerabilities, and/or risks, etc., created by the meta-data and/or data (and/or lack thereof) of one or more family history related information, the mechanism comprising: one or more computer-implementable instructions and/or rules based on, e.g., one or more family history related information, content, data, meta-data, and/or calculations.
rank—to classify and/or to give a particular order and/or position to.
real-world—human reality and/or the practical (as opposed to theoretical) world.
receive—to get as a signal, take, acquire, and/or obtain.
recommend—to suggest, praise, commend, and/or endorse.
render—to, e.g., physically, chemically, biologically, electronically, electrically, magnetically, optically, acoustically, fluidically, and/or mechanically, etc., transform information into a form perceptible to a human as, for example, data, commands, text, graphics, audio, video, animation, and/or hyperlinks, etc., such as via a visual, audio, and/or haptic, etc., means and/or depiction, such as via a display, monitor, electric paper, ocular implant, cochlear implant, speaker, vibrator, shaker, force-feedback device, stylus, joystick, steering wheel, glove, blower, heater, cooler, pin array, tactile touchscreen, etc.
repeatedly—again and again; repetitively.
repository—one or more memories, electronic files, and/or databases.
request—to express a desire for and/or ask for.
resident—comprised, located, appearing, living, and/or operating within.
rule—a conditional expression, typically in “If X, then Y” format, that defines one or more consequents (e.g., Y) based on one or more antecedents (e.g., X).
scheme—a collection of rules and/or a systematic plan of action,
score—(n) a tally, result, and/or numerical value resulting from an evaluation with respect to a predetermined criterion; (v) to evaluate with respect to a predetermined criterion.
search—(v) to investigate, examine, and/or probe; (n) an examination and/or investigation.
second—a cited element of a set that follows and/or is in addition to an initial element.
select—to chose and/or to make and/or indicate a choice and/or selection from among alternatives.
sequential—ordered in time and/or position.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
share—to possess, have, and/or be characterized by.
signal—(v) to communicate; (n) one or more automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that can encode information, such as machine-implementable instructions for activities and/or one or more letters, words, characters, symbols, signal flags, visual displays, and/or special sounds, etc., having prearranged meaning Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
sort—to arrange in a defined order and/or sequence.
special purpose computer—a particular computer and/or information device comprising a processor device having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
special purpose processor—a particular processor device, having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
store—to place, hold, and/or retain data, typically in a memory.
string—a serial arrangement.
subset—a portion of a set.
substantially—to a great extent and/or degree.
support—to evidence, explain, corroborate, justify, and/or validate.
switch—(v) to: form, open, and/or close one or more circuits; form, complete, and/or break an electrical and/or informational path; select a path and/or circuit from a plurality of available paths and/or circuits; and/or establish a connection between disparate transmission path segments in a network (or between networks); (n) a physical device, such as a mechanical, electrical, and/or electronic device, that is adapted to switch.
symbol—one or more characters, letters, numbers, and/or words.
system—a collection of mechanisms, devices, machines, articles of manufacture, processes, data, and/or instructions, the collection designed to perform one or more specific functions.
target—a thing at which a desire, action, and/or designation is directed.
to—a preposition adapted for use for expressing purpose and/or direction.
transform—to change in measurable: form, appearance, nature, and/or character.
transmit—to send as a signal, provide, furnish, and/or supply.
trend chart—a graphical rendering of a multiple data displayed as a function of time.
trust metric—a measure of confidence.
undefined—lacking a definition.
unique—existing as the only one, having no equal, and/or distinctive in some attribute.
unrelated—not associated with.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
user-specified—identified by a user of the computer and/or a system comprising the computer.
value—a measure of estimated and/or actual strategic, tactical, legal, and/or financial worth, and/or a measured, assigned, determined, and/or calculated quantity or quality for a variable and/or parameter.
via—by way of, with, and/or utilizing.
weight—a value indicative of importance, e.g., a value assigned to a number in a computation, such as in determining an average, to make the number's effect on the computation reflect its importance.
weighted score—a score reflecting a product of a score and a weight.
wherein—in regard to which; and; and/or in addition to.

### NOTE

Various substantially and specifically practical and useful exemplary embodiments of the claimed subject matter are described herein, textually and/or graphically, including the best mode, if any, known to the inventor(s), for implementing the claimed subject matter by persons having ordinary skill in the art. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects skilled artisans to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”;
any two or more described substances can be mixed, combined, reacted, separated, and/or segregated;
any described characteristics, functions, activities, substances, and/or structural elements can be integrated, segregated, and/or duplicated;
any described activity can be performed manually, semi-automatically, and/or automatically;
any described activity can be repeated, any activity can be performed by multiple entities, and/or any activity can be performed in multiple jurisdictions; and
any described characteristic, function, activity, substance, and/or structural element can be specifically excluded, the sequence of activities can vary, and/or the interrelationship of structural elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any phrase (i.e., one or more words) appearing in a claim is followed by a drawing element number, that drawing element number is exemplary and non-limiting on claim scope.

No claim of this document is intended to invoke paragraph six of 35 USC 112 unless the precise phrase “means for” is followed by a gerund.

Any information in any material (e.g., a United States patent, United States patent application, book, article, etc.) that has been incorporated by reference herein, is incorporated by reference herein in its entirety to its fullest enabling extent permitted by law yet only to the extent that no conflict exists between such information and the other definitions, statements, and/or drawings set forth herein. In the event of such conflict, including a conflict that would render invalid any claim herein or seeking priority hereto, then any such conflicting information in such material is specifically not incorporated by reference herein. Any specific information in any portion of any material that has been incorporated by reference herein that identifies, criticizes, or compares to any prior art is not incorporated by reference herein.

Within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. A device, comprising:
an automated story generator that comprises a special purpose processor adapted to automatically:
access a plurality of crowd-sourced assertions from one or more predetermined databases, each of the one or more predetermined databases served by one or more predetermined physical servers;
assign a rank to each crowd-sourced assertion from the plurality of crowd-sourced assertions to form a ranked plurality of crowd-sourced assertions, each rank a reflection of a probabilistically-determined level of interest in the corresponding crowd-sourced assertion;
select a portion of the ranked plurality of crowd-sourced assertions, each crowd-sourced assertion in the portion having a rank that fulfills a predetermined ranking criteria;
from the portion of the ranked plurality of crowd-sourced assertions, generate a first machine-generated passage that demonstrates the one or more predetermined story elements, the first machine-generated passage comprising a first randomly-selected phrase from a first list of pre-determined phrases, the first machine-generated passage comprising one or more personal assertions that are directly related to a predetermined individual;
from the portion of the ranked plurality of crowd-sourced assertions, generate a second machine-generated passage that demonstrates the one or more predetermined story elements, the second machine-generated passage comprising a second randomly-selected phrase from a second list of pre-determined phrases, the second machine-generated passage comprising one or more general assertions that affect the predetermined individual and a plurality of people who are not in the family of the predetermined individual;
combine the first machine-generated passage, the second machine-generated passage, and one or more other machine-generated passages in a predetermined order to form a first story, each of the machine-generated passages of the first story perceivable by a human for each assertion that machine-generated passage comprises; and
store the first story in a machine-readable medium that comprises a physical structure.

2. A method comprising:
via an automated story generator that comprises a special purpose processor, automatically:
accessing a plurality of crowd-sourced assertions from one or more predetermined databases, each of the one or more predetermined databases served by one or more predetermined physical servers;
assigning a rank to each crowd-sourced assertion from the plurality of crowd-sourced assertions to form a ranked plurality of crowd-sourced assertions, each rank a reflection of a probabilistically-determined level of interest in the corresponding crowd-sourced assertion;
selecting a portion of the ranked plurality of crowd-sourced assertions, each crowd-sourced assertion in the portion having a rank that fulfills a predetermined ranking criteria;
from the portion of the ranked plurality of crowd-sourced assertions, generating a first machine-generated passage that demonstrates the one or more predetermined story elements, the first machine-generated passage comprising a first randomly-selected phrase from a first list of pre-determined phrases, the first machine-generated passage comprising one or more personal assertions that are directly related to a predetermined individual;
from the portion of the ranked plurality of crowd-sourced assertions, generating a second machine-generated passage that demonstrates the one or more predetermined story elements, the second machine-generated passage comprising a second randomly-selected phrase from a second list of pre-determined phrases, the second machine-generated passage comprising one or more general assertions that affect the predetermined individual and a plurality of people who are not in the family of the predetermined individual;
combining the first machine-generated passage, the second machine-generated passage, and one or more other machine-generated passages in a predetermined order to form a first story, each of the machine-generated passages of the first story perceivable by a human for each assertion that machine-generated passage comprises; and
storing the first story in a machine-readable medium that comprises a physical structure.

3. A first machine-readable medium comprising a first physical structure and storing processor-implementable instructions for activities comprising:
via an automated story generator that comprises a special purpose processor, automatically:
accessing a plurality of crowd-sourced assertions from one or more predetermined databases, each of the one or more predetermined databases served by one or more predetermined physical servers;
assigning a rank to each crowd-sourced assertion from the plurality of crowd-sourced assertions to form a ranked plurality of crowd-sourced assertions, each rank a reflection of a probabilistically-determined level of interest in the corresponding crowd-sourced assertion;
selecting a portion of the ranked plurality of crowd-sourced assertions, each crowd-sourced assertion in the portion having a rank that fulfills a predetermined ranking criteria;
from the portion of the ranked plurality of crowd-sourced assertions, generating a first machine-generated passage that demonstrates the one or more predetermined story elements, the first machine-generated passage comprising a first randomly-selected phrase from a first list of pre-determined phrases, the first machine-generated passage comprising one or more personal assertions that are directly related to a predetermined individual;
from the portion of the ranked plurality of crowd-sourced assertions, generating a second machine-generated passage that demonstrates the one or more predetermined story elements, the second machine-generated passage comprising a second randomly-selected phrase from a second list of pre-determined phrases, the second machine-generated passage comprising one or more general assertions that affect the predetermined individual and a plurality of people who are not in the family of the predetermined individual;
combining the first machine-generated passage, the second machine-generated passage, and one or more other machine-generated passages in a predetermined order to form a first story, each of the machine-generated passages of the first story perceivable by a human for each assertion that machine-generated passage comprises; and
storing the first story in a second machine-readable medium that comprises a second physical structure.
